(19) United States
(12) Patent Application Publication
(10) Pub. No.: US 2017/0091403 A1
(43) Pub. Date: Mar. 30, 2017

(54) System And Method For Predicting Effectiveness of Animal Treatments

(71) Applicant: GlobalVetLINK, L.C., Ames, IA (US)

(72) Inventor: Kevin D. Maher, Ames, IA (US)

(21) Appl. No.: 15/311,467

(22) PCT Filed: May 15, 2015
(86) PCT No.: PCT/US15/31229

§ 371 Date: Nov. 15, 2016

Related U.S. Application Data
(60) Provisional application No. 61/994,090, filed on May 15, 2014.
(60) Provisional application No. 62/065,962, filed on Oct. 20, 2014.

(51) Int. Cl. G06F 19/00

(52) U.S. Cl. CPC G06F 19/345; G06F 19/325; G06F 19/3456

(57) ABSTRACT

A computer-implemented method for determining an ideal treatment plan for a herd of animals includes the steps of testing a statistically significant sample individual animals of the herd for prevalence of a particular disease, collecting at least two animal parameters for each animal of the statistically significant sample, generating lab results determining the existence of the particular disease for each animal of the statistically significant sample, comparing the generated lab results against a database containing information on the particular disease for animals matching the at least two parameters collected from the statistically significant sample, and outputting an ideal herd treatment plan for the herd based on the results of the step of comparing.

### RELATED APPLICATIONS

This application claims priority to U.S. Patent Application Ser. No. 61/994,090, titled “System and Method for Predicting Effectiveness of Animal Treatments” filed May 15, 2014, and to U.S. Patent Application Ser. No. 62/065,962, titled “System and Method for Predicting Effectiveness of Animal treatments”, filed Oct. 20, 2014, each of which is incorporated herein by reference.

This application is also related to U.S. patent application Ser. No. 13/446,865, titled “System and method for Storing and Presenting Animal Certification Information,” filed Apr. 13, 2012, which claims priority to U.S. Patent Application Ser. No. 61/475,041, filed Apr. 13, 2011.

### BACKGROUND

Animal health certificates (or related inspection documents with similar name and purpose) are required to move animals such as livestock, pets, and show animals, across state lines within the United States of America. These certificates are a hand-completed 4-part carbon form that includes information of the animal being moved, including necessary test results performed on the animal for the required movement. The owner must produce a certificate for each animal being moved when transporting animals across state lines, for example. The time to obtain a certificate usually takes one to three days and in most cases the obtained certificate is valid for up to one month.

To obtain an Equine Infectious Anemia or ‘Coggins’ certificate for a particular animal, an owner brings the animal to a veterinarian or the veterinarian goes to the location of the animal, where blood is drawn from the animal. Information of the owner and the animal, including three sketches of the animal showing its distinguishing features, are added to the forms. For example, for a horse, sketches are made of each side view of the animal, and a frontal head view, wherein distinguishing features, such as patterns in the coat, are included in the sketch. Information of the veterinarian, a laboratory that will perform tests on the blood, and associated addresses, are added to the forms, and the blood and forms are sent (e.g., using a postal or delivery service) to the laboratory.

Upon receiving the blood and form, the laboratory performs required tests on the blood, adds the results of these tests to the form, which when complete with the veterinarian and laboratory information forms the certificate. The laboratory keeps and files one part of the form, one part goes to the state animal health official, and the remaining parts of the form are sent back to the veterinarian. The veterinarian keeps and files one part of the form, and sends one part to the owner.

These hand-completed certificates and the labor-intensive process for generating them is subject to errors, missing data, and misplacement. For example, if the owner loses a certificate when in transit, the owner must request a new copy of the form from the veterinarian or the laboratory, and wait for that copy to be sent (e.g., faxed or mailed) to them.

### SUMMARY

In one embodiment, a computer-implemented system is used for animal certification. The system includes a database for storing rules and regulations that define requirements for the animal certification, a web interface for receiving a request for a certificate for an animal, a requirement interpreter for generating a procedure for acquiring information required to complete the certificate based upon the rules and regulations and a type of the certificate, a certificate engine for collecting information for the certificate based upon the procedure, and a certificate producer for generating the certificate based upon the collected information and for storing the certificate within the database.

In another embodiment, a computer-implemented method issues a certificate for an animal. A request to generate the certificate is received and required information for the certificate is determined based upon rules and regulations, stored within a database, that define information requirements for the certificate. The method interacts with one or more of an owner of the animal, a certified veterinarian, and a laboratory to collect the required information. The certificate is generated with a unique identifier when the required information is complete, and the certificate is stored within the database.

In another embodiment, a device determines validity of a certificate for an animal. The device includes a network interface for communicating with a certification system, a user interface for interacting with a user of the device, and an application running on the device. The application has machine-readable instructions that when executed by a processor of the device (a) determines identification information associated with the certificate, (b) sends the identification information to the certification system, (c) receives, from the certification system, an indication of validity of the certificate, and (d) displays the indication on the user interface.

In another embodiment, a computer-implemented system provides animal certification. The system includes a database that stores rules and regulations that define requirements for the animal certification, a web interface for receiving a request for a certificate for an animal, a certificate engine for collecting information required to complete the certificate based upon the rules and regulations and a type of the certificate, an information validator for validating the collected information against the rules and regulations to determine whether the collected information is sufficient to complete the certificate and is valid, and a certificate producer for generating the certificate based upon the collected information and for storing the certificate within the database

### BRIEF DESCRIPTION OF THE FIGURES

FIG. 1 shows one exemplary system for storing and presenting animal certification information, in an embodiment.

FIG. 2 shows exemplary detail of the system of FIG. 1, in an embodiment.

FIG. 3 is a flowchart illustrating one exemplary method for storing and presenting animal certification information, in an embodiment.

FIG. 4 is a flowchart illustrating one exemplary method for the step of collecting information of the method of FIG. 3, in an embodiment.

FIG. 5 is a schematic diagram illustrating exemplary use of the system of FIG. 1 to verify authenticity of a presented certificate for an animal passing through a control point, in an embodiment.

FIG. 6 is a flowchart illustrating one exemplary method for validating an identified certificate within the system of FIG. 1.

FIG. 7 is a schematic showing exemplary detail of the certificate of FIG. 1.

FIG. 8 is an image of one exemplary certificate produced by the system of FIG. 1 and printed by the owner using printer.

FIG. 9 shows one exemplary laboratory submittal form with a machine readable code that facilitates tracking of a blood sample, sent by a veterinarian to a laboratory, within the system of FIGS. 1 and 2, in an embodiment.

FIG. 10 shows one exemplary veterinary inspection certificate that is generated by the system of FIGS. 1 and 2 to indicate inspection of the animal by the certified veterinarian, in an embodiment.

FIG. 11 shows one exemplary prescription certificate for use of medication within animal feed, as tracked by the system of FIGS. 1 and 2, in an embodiment.

FIG. 12 shows one exemplary certificate generated by the system of FIGS. 1 and 2 as required to move a horse between states, in an embodiment.

FIG. 13 shows one exemplary method for generating a procedure for collecting required information for the certificate of FIGS. 1 and 2, in an embodiment.

FIG. 14 shows further exemplary detail of the system of FIG. 1, in an embodiment.

FIG. 15 shows one exemplary method for recommending an ideal treatment for an animal based upon test results from tests of a specimen collected from the animal.

FIG. 16 shows further exemplary detail of the software and database of the system of FIG. 1, illustrating a feed engine that is implemented as machine readable instructions within software that are executable to generate a veterinary feed directive based upon one or more of treatment plans, animal records, and animal grouping.

FIG. 17 depicts a method for providing effectiveness of animal treatments via a smart connection between a central server and an isolated user device, in one embodiment.

FIG. 18 shows one exemplary method for determining an ideal immunization plan and predicting results of the immunization plan, in an embodiment.

FIG. 19 shows one exemplary off-line capable device for implementing certain functionality of the system of FIG. 1 without requiring continuous connectivity to the system, in an embodiment.

FIGS. 20 and 21 are flowcharts illustrating exemplary methods for preparing the device of FIG. 19 for off-line operation, in one embodiment.

FIGS. 22 and 23 are flowcharts illustrating exemplary methods for resynchronizing the system of FIG. 1 with the device of FIG. 19 after off-line operation of the device.

FIG. 24 shows further exemplary detail of the software and database of the system of FIG. 1, illustrating automatic testing of one or more animals based upon a directive, in one embodiment.

### DETAILED DESCRIPTION OF THE EMBODIMENTS

The present disclosure may be understood by reference to the following detailed description taken in conjunction with the drawings as described below. For purposes of illustrative clarity, certain elements in the drawings are not drawn to scale. In the following description, animal movement examples are used, as animal movement between states of the USA requires certification; however, the systems and methods described herein may be applied to all known and future animal health certification requirements.

In the following description, the term “ideal”, when used with selecting one of a treatment, a treatment plan, and an immunization plan for example, indicates that the most appropriate treatment, treatment plan, and immunization plan is selected based upon one or both of informed and data analysis.

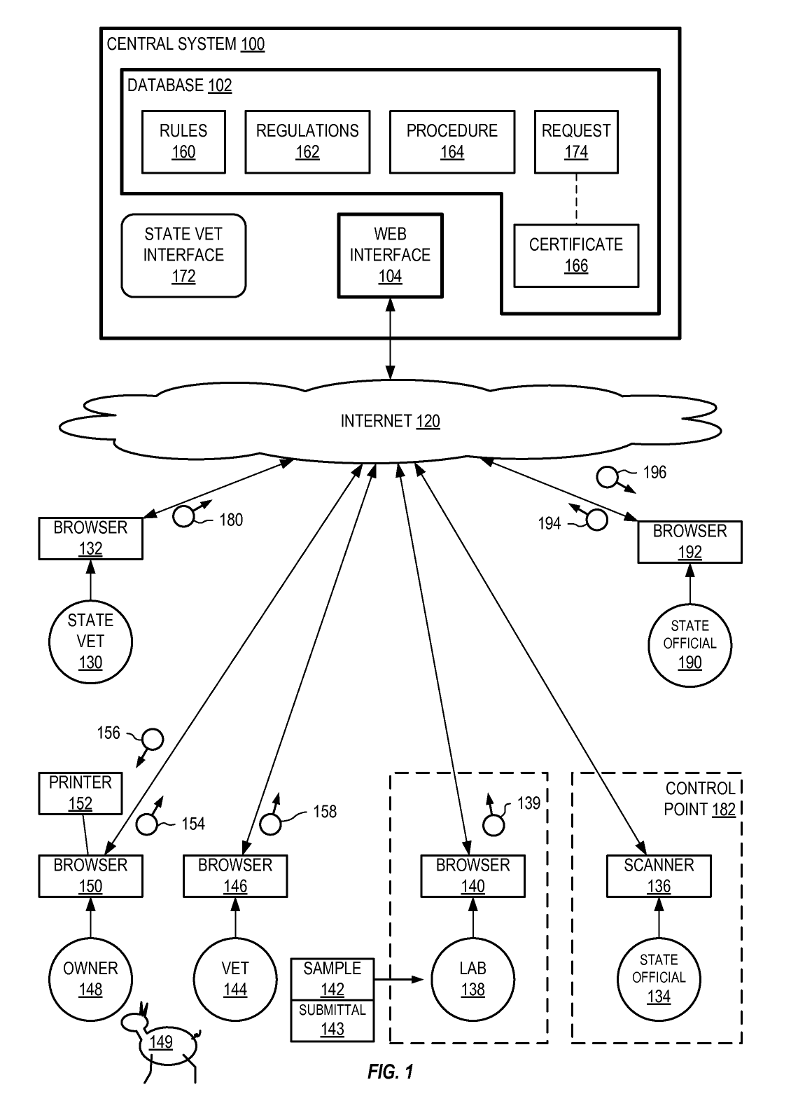

FIG. 1 shows one exemplary system 100 for storing and presenting animal certification information. System 100 is shown with a database 102 and a web interface 104 that connects to Internet 120. Internet 120 represents the World Wide Web for example. System 100 is for example constructed of one or more servers that support and control access to database 102 via web interface 104. Database 102 is for example a relational database implemented using a mass data storage device (e.g., a network storage device).

Web interface 104 provides a secure access portal to system 100, via Internet 120, for a state veterinarian 130, one or more state officials 134 and 190, a laboratory 138, an accredited veterinarian 144, and an animal owner 148. For example, web interface 104 may include one or more web addresses (URLs) that allow access to system 100 from web browsers and/or other Internet connected devices. Functionality of system 100 is for example implemented as “software as a service” (SaaS), known in the art. State veterinarian 130, state official 190 (e.g., federal and international officials), laboratory 138, accredited veterinarian 144, and owner 148 utilize browsers 132, 140, 146, 150, and 192, respectively, to access services of system 100 via Internet 120 and web interface 104. Each browser 132, 140, 146, 150, and 192 may operate on one of a personal computer, a smart phone, a personal digital assistant, television, and other Internet and network enabled devices.

System 100 supports certification of all types of animal, including avian, bovine, canine, caprine, cervid, equine, feline, ovine, poultry, swine, zoological, aquatic, and other species. System 100 receives and stores (e.g., within database 102) many forms of animal identification that are entered into system 100 by accredited veterinarians including: visual tags, electronic identification devices, digital photographs, iris or retina identifying properties, DNA profile of the disease agent and/or animal(s), premises identification, and more. For example, data may be entered by accredited veterinarian 144, using browser 146, into system 100 from a spreadsheet and/or a text file. In the following examples, certain types of certificate are shown; however, system 100 may operate with many additional types of certificate without departing from the scope hereof. In one embodiment, accession numbers are generated by laboratory 138 (e.g., using a manual process or are generated using an internal laboratory information management system that may, or may not, be integrated into the system), and then applied to certificate 166. In one embodiment, system 100 includes a laboratory integration option that allows laboratory 138 to electronically apply accession numbers and results 139 to certificate 166, including a date the sample was received, a date that the results were reported, a name of a technician performing the tests, and a signature of the technician.

State veterinarian 130 maintains state rules and state regulations within system 100 that define requirements for moving animals into and within their respective state, for example. In one example of operation, state veterinarian 130 uses browser 132 to update rules 160 and regulations 162 within database 102 of system 100. Rules 160 and regulations 162 define requirements for certification of animal movement within states and between states, and may be updated electronically in real-time as disease and health conditions change. In one example of operation, state veterinarian 130 prepares an update file 180 that defines additions, amendments, and/or cancellations to rules and regulations for animal movement into and within their state. In another example of operation, state vet 130 is a livestock event venue official that prepares update file 180 defining additions, amendments, and/or cancellations to rules and regulations for animal movement into and within their event venue. File 180 is uploaded to system 100 via browser 132, Internet 120 and web interface 104, and processed by a state veterinarian interface 172 within system 100 that updates rules 160 and regulations 162 within database 102 based upon file 180. Each state within the United States of America has at least one state animal health official (e.g., a state veterinarian 130 or lay person appointed by the state) for example who is authorized to update these rules and regulations within system 100. Also, livestock event officials may be appointed as state animal health official upon approval of state veterinarian 130.

In one embodiment, rules 160 define which certificates are required for a particular state, and regulations 162 define which information is required for those certificates within that state. For example, to move a horse from a first to a second state, rules 160 define that, for the second state, a valid Equine Infectious Anemia certificate is required for the horse before it will be allowed to enter the second state. Regulations 162 define that, for the second state, the Equine Infectious Anemia certificate requires a blood test to have been performed by an accredited laboratory within a predefined period prior to the intended movement of the animal, and that the test results are negative. Regulations 162 may also specify that the certificate identify the animal and its location within the first state, that the certificate lists the veterinarian that drew the blood sample from the animal and lists the laboratory used to test the sample. Regulations 162 may also specify that the information be digitally signed by the owner, the veterinarian, and the laboratory to attest to its validity. System 100 facilitates compliance to the appropriate rules and regulations by owner 148 when moving an animal 149 from a starting location to a destination. In another example, rules 160 and regulations 162 may define that an animal moving from a first state to a second state has a valid certificate indicating that it has been examined and/or has had certain inoculations.

To move animal 149, owner 148 contacts veterinarian 144 to request a certificate for moving animal 149 from a start location (e.g., the owner's stables) to a destination (e.g., a stock show in a neighboring state). In one example, owner 148 sends a message 154, using browser 150, to system 100 requesting a certificate for moving animal 149. System 100 stores a request 174 within database 102 and notifies veterinarian 144 that owner 148 has requested the certificate for animal 149. In another example, owner 148 contacts local accredited veterinarian 144 directly to request the certificate for animal 149, wherein veterinarian 144 interacts with system 100 to create request 174.

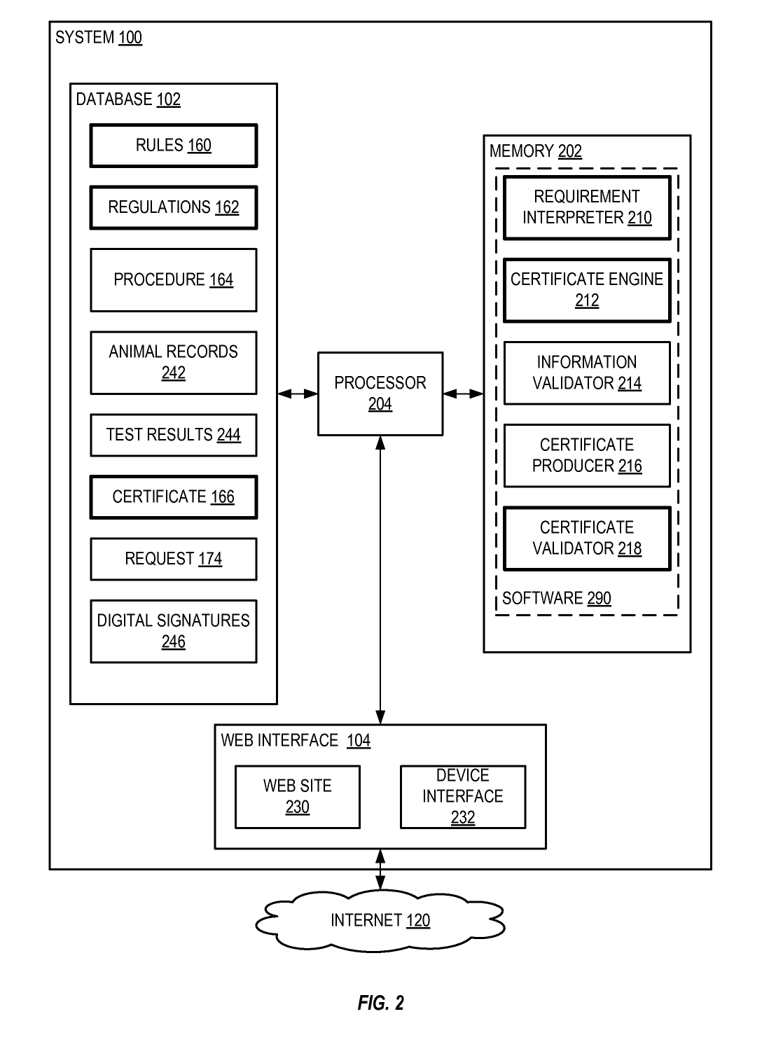

Certification for moving animals requires an accredited veterinarian (e.g., veterinarian 144) to certify that the certificate 166 correctly identifies the animal 149 to be moved, and that blood samples were taken from that animal and sent for testing at an accredited laboratory (e.g., laboratory 138), and/or that vaccinations were administered to the animals according to entry requirements. The laboratory verifies that test results are derived from the sample sent by the veterinarian. Vaccinations or similar requirements may be entered into system 100 by veterinarian 144. Each owner, veterinarian, and laboratory that uses system 100 has a unique digital signature (eSignature) stored within system 100 (e.g., within database 102, see digital signatures 246 of FIG. 2) that is accessed using a login username and password of the owner, veterinarian, and laboratory, respectively. When information is entered into system 100, the party entering the information applies their digital signature to indicate that the supplied information is authentic and correct. Certificates may be validated by verifying that the digital signature applied to a certificate is authentic and that it is appropriate for its use on the certificate. The certificate itself may be validated within system 100. For example, within system 100, a digital certificate process runs in the background as part of a comprehensive security measure to further ensure security of the document.

In one embodiment, web interface 104 interactively displays, in response to receiving information on the desired movement of the animal (e.g., a destination state for import) and a type of the animal, certain ones of rules 160 and regulations 162 that are applicable to generating certificate 166 for movement of the animal. That is, web interface 104 publically displays, in real-time, animal import regulations related to inspection, vaccinations, tests, animal identification, and other requirements related to compliance with current animal import regulations for a state.

Request 174 identifies owner 148, veterinarian 144 and at least a type of animal 149, together with the start location and the destination of the requested movement for animal 149. System 100 determines an appropriate certificate 166 for the requested movement of animal 149 based upon rules 160 and regulations 162 of the state or states involved in the movement. Typically, certification is required only for the destination state. However, state requirements may vary, for example in the case of a national disease emergency, each state through which the animal is to pass may require a certificate and/or have additional entry requirements. System 100 determines the requirements for each transited state and generates required certificates automatically. For example, where animal 149 is to pass through one or more intermediate states when moving from the start location to the destination, system 100 determines, based upon rules 160 and regulations 162 for each state, certification requirements and generates required certificates.

Veterinarian 144 interacts with system 100 via browser 146, Internet 120, and web interface 104, to enter information 158 associated with request 174 and certificate 166. For example, veterinarian 144 may enter contact information for himself and of owner 148, details of the requested movement of animal 149, and identification information of animal 149. In one example, where animal 149 is a horse, veterinarian 144 may capture digital images showing distinguishing marking of animal 149, and send these images to system 100 where they are stored in association with request 174 and certificate 166. Other types of animals may be identified by other means, such as visual tags, RFID tags, DNA profile, Iris or Retina attributes, and so on. Veterinarian 144 may take a sample 142 (e.g., draw blood) from animal 149 and send sample 142 to laboratory 138 for testing based upon testing requirements of certificate 166.

System 100 may store information of owner 148, veterinarian 144, and animal 149 within database 102 for future reference such that veterinarian 144 and/or owner 148 need not enter the same information each time a certificate is requested for movement of animal 149. In one example of operation, owner 148 and/or veterinarian 144 select the information from one or more lists displayed by system 100. In another example of operation, system 100 automatically determines the information from database 102 based upon identification of animal 149 and/or regulations 162.

Upon receiving sample 142, laboratory 138 performs test specified by veterinarian 144 and/or system 100, and uploads test results 139 to system 100 via browser 140, Internet 120, and web interface 104. Sample 142 may include identification information that identified one or both of request 174 and certificate 166 within database 102, wherein laboratory 138 identifies the request or certificate within test results 139.

System 100 attaches digital signatures from laboratory 138 (e.g., upon authority of a technician at laboratory 138) and veterinarian 144 to certificate 166 as proof that certificate 166 conforms to required practice. Once all required portions of certificate 166 are complete, system 100 produces certificate 166 for use by owner 148. In one example, system 100 notifies veterinarian 144 that certificate 166 is complete and ready for use by owner 148, wherein veterinarian 144 may then notify owner 148. In another example, system 100 notifies both veterinarian 144 and owner 148 that certificate 166 is complete and ready for use, wherein owner 148 then prints certificate 166 on a local printer 152 connected to browser 150. Access to certificate 166 by owner 148 may be at the discretion of veterinarian 144, occurring via barcode/QR code scanning (or similar image) as well as other electronic media retrieval.

In one embodiment, system 100 provides a communication mechanism that allows communication (e.g., message passing, VoIP communication) between laboratory 138, veterinarian 144 and owner 148. For example, owner 148 and/or veterinarian 144 may submit Equine Infectious Anemia (EIA) analysis (and/or other required tests) requests and receive results in near real-time.

Specifically, system 100 includes one or more applications that facilitate submission of data by owner 148, veterinarian 144, and laboratory 138.

Exemplary certification supported by system 100 includes Official Certificates of Veterinary Inspection (OCVI), Online EIA (Coggins Certificates), and Electronic Veterinary Prescription Certificate System (eVRx® to be rebranded ScriptLINK®), For Sale Certificate (Pre-Purchase Exam), Pre-Conditioning Certificate, Vaccination Certificates, Insurance or Related Exam Certificate, and other Lab Test Certificates. An OCVI certificate is used by accredited veterinarians to efficiently document animal health status to meet official interstate movement requirements. Coggins certificates provide Equine Infectious Anemia certification utilizing digital photos and digital signatures (eSignatures) and integrate diagnostic laboratory data with information provided by accredited veterinarians based upon requirements by state/provincial/federal animal health officials. As described below, digital signatures are maintained within database 102 and provide a secure, traceable, and verifiable means for authenticating certificates. The Coggins certificates are approved by USDA-APHIS-VS to support documentation for international movement of horses. System 100 allows veterinarians to create, update, and standardize all client prescriptions (e.g., eVRx® certificates), along with documentation of a current veterinarian-client-patient-relationship. The veterinarian may manage multiple production site prescriptions, or other client's animal prescriptions, quickly renew prescriptions prior to expiration, create and manage multiple prescriptions within system 100, and conform to the North American Compendium for current swine (and other species) product labeling.

In one example of operation, browser 146 operates on a portable Internet connected device (e.g., a smart phone or tablet) to allow veterinarian 144 to access system 100 when visiting animal 149 at the stable or location of animal 149. Mobile device access to system 100 allows veterinarian 144 to create prescription certificates (e.g., eVRx® certificates), administer injections, and document these administrations, as required by state and/or Federal regulations, such as for animals used for food products. System 100 records such documentation within database 102, thereby allowing veterinarian 144 to retrieve this documentation later. System 100 thereby simplifies veterinary practice by allowing veterinarian 144, while traveling to visit animals, to prescribe, administer, and document medications given to animals. System 100 may also provide reminders and/or other prompts to each handling veterinarian for prescriptions that are to be repeated. Even when prescriptions have expired, associated information remains stored within database 102 for future reference, thereby allowing owners, veterinarians, drug producers, DVMs, and distributors to track the use of specific drugs through access to system 100. For example, system 100 may provide statistical data to drug manufacturers showing demographics of where their product is used. Further, product use is fully traceable within system 100 allowing owners and drug manufacturers and food industry customers to identify animals that have used a specific drug. In one embodiment, system 100 provides details such as: farm name, address (e.g., a premises number and/or emergency address), animals treated (e.g., a total number of animals, animals listed by a group and/or a lot number, or listed by individual animal identity, phase of production, etc.), product (drug) name, dosage instructions, route of administration, withdrawal notice, special instructions, GPS location, and may order visits and treatments by heard health status.

Certain state regulations require that examination certificates are provided by vendors of certain animals, such as cats and dogs in the state of Florida for example. Within these states, tests, vaccines, and anthelmintics must be administered according to state and/or local requirements, and a certificate obtained before the animal is offered for sale, unless a licensed, accredited veterinarian certifies that the application is not in the best medical interest of the animal on an official certificate of veterinary inspection (OCVI) for the animal. System 100 facilitates compliance to state and local requirements and provides rapid and verifiable certification. For example, system 100 facilitates vendor and veterinarian compliance to Statute 828.29 within the state of Florida.

In another example, for Iowa, system 100 implements a preconditioned calf certification system, wherein certain calf labeling (e.g., Preconditioned, Green Tag, and Gold Tag) is based upon inspection by a licensed veterinarian and verification that all required treatments, vaccinations and program requirements have been performed before a calf may be so labeled. This system provides a validated, third-party method of animal health certification and qualification for the Green and Gold Tag programs, and thus provides more confidence of health by purchasers.

System 100 supports GoPass® which is a 6 month equine movement passport certificate. System 100 provides a fast alternative to the conventional 30 day paper-based certificate procedure for moving horses for up to six months within the U.S. The GoPass uniquely validates animal qualification into the appropriate GoPass region, by logic maintained within system 100 (for example within rules 160 and regulations 162). A movement itinerary is also part of the system, which the animal owner may access, and report to state animal health officials of real-time animal movements within the approved GoPass region.

System 100 also facilitates issue, by veterinarian 144, of prescription certificates for feed grade antibiotic use in swine rations, wherein system 100 stores associated data (e.g., data relating to feed mills) within database 102 and provides prescription reporting and verification. System 100 meets FDA requirements for electronic transmission of data and documents, as well as it meets FDA eSignature statute: 21CFR Part 11, and follows guidance 120 associated therewith. Guidance 120 is defined within FDA document, see for example: http://www.fda.gov/downloads/AnimalVeterinary/GuidanceComplianceEnforcement/GuidanceforIndustry/UCM052660.pdf. Further technical requirements for digital signature (eSignature) acceptance by the FDA and required by Guidance 120 may be found at http://www.fda.gov/RegulatoryInformation/Guidances/ucm125067.htm.

In one embodiment, system 100 implements an owner web site (e.g., www.MyVetLink.com) that allows owner 148 read-only access to electronic health documents, via username and password that are provided online by veterinarian 144 and laboratory 138. For example, test results that are part of animal movement certification may be accessed by owner 148. Where veterinarian 144 and/or laboratory 138 has performed other test on animals of owner 148, owner 148 may view data on these test and/or test results using browser 150 to access system 100. This access avoids delays for data access by owners, promotes validated and approved animal movements, and improves the level of service provided to veterinary clients. System 100 may include other authorized web sites and/or portals to other systems (e.g., partners of system 100) to provide additional information and services to one or more of owner 148, veterinarian 144 and laboratory 138.

Official Access to Stored Information

System 100 allows state official 134 (e.g., animal health officials from all fifty states of the U.S.) to generate, in real-time, reports for certain data stored within database 102, and particularly relating to certificates 166. For example, state official 134 may query system 100 and generate a report for one or more of regulatory animal imports, exports, intrastate movements, as well as laboratory testing. Additional reporting attributes include: animal identifiers (multiple), owner name and location, veterinarian, premises, species, species category, purpose of movement, destination, tests, vaccinations, and data export for integration into other systems. International certificate and connectivity may occur with the system, supporting languages and units of measure, meeting the country of import's movement requirements. System 100 allows integration partners to incorporate functionality into their system to allow their licensed users to access certain information stored within system 100 and to generate Health Documents. Appropriate documentation is provided on system 100 to facilitate interfacing with partner systems upon request, however partner systems would be responsible for making detailed reports available to their licensees.

Reference Information

In one embodiment, system 100 provides additional information relating to animal testing and regulations. For example, prior to initiating veterinary test and procedure, owner 148 may access system 100 to determine regulations and requirements for moving animal 149 from the start location to the destination. In another example, system 100 provides a searchable directory of aquaculture laboratories that allows searching based upon tests that are available by state, laboratory, type of aquaculture, and so on.

FIG. 2 shows exemplary detail of system 100 of FIG. 1. System 100 is shown with database 102, web interface 104, a memory 202 and a processor 204. Memory 202 may represent one or more of a hard drive, volatile memory, non-volatile memory, network storage, and so on, and is shows storing software 290 of system 100. In one embodiment, database 102 is stored within memory 202. In another embodiment, database 102 is stored within one or more network storage devices that are coupled with processor 204. Processor 204 may represent one or more processors and/or processor cores that execute instructions of software 290 to implement functionality of system 100. Web interface 104 is also implemented, at least in part, by software (not shown) stored within memory 202. In one embodiment, web interface 104 is implemented on a separate server that couples and cooperates with processor 204.

Software 290 includes a requirement interpreter 210, a certificate engine 212, an information validator 214, a certificate producer 216, and a certificate validator 218. Requirement interpreter 210 is an algorithm that processes rules 160 and regulations 162 to generate procedures 164 that define steps required for obtaining certificate 166 for movement of an animal based upon request 174. In one example of operation, requirement interpreter 210 is invoked by web interface 104 when owner 148 and/or veterinarian 144 creates request 174, to generate procedure 164 that defines the necessary steps for obtaining information required to generate certificate 166 based upon state requirements.

Certificate engine 212 is an algorithm that interprets procedure 164 and interacts, via web interface 104, with one or more of owner 148, veterinarian 144 and laboratory 138 to collect information required to complete certificate 166 that will allow owner 148 to move animal 149. For example, certificate engine 212 interacts (e.g., using web interface 104) with owner 148 and/or veterinarian 144 to collect information including information of owner 148, veterinarian 144, the species of animal 149, and the desired purpose of movement, wherein a digital signature is provided by the owner and/or veterinarian to provide authenticity of the information. System 100 stores digital signatures 246 within database 102, and applies selected and authorized ones of these digital signatures to certificate 166. For example, owner 148 enters a username and password to apply his/her digital signature to certificate 166 once they have verified that information within certificate 166 is correct. Similarly, veterinarian 144 and a technician of laboratory 138 apply their respective digital signature from digital signatures 246 using their respective username and password. Based upon the requested certificate, certificate engine 212 may instruct veterinarian 144 to collect a blood sample 142 from animal 149 for testing by laboratory 138 and then certificate engine 212 interacts with laboratory 138 to collect and store, within database 102, test results 244 from testing of sample 142. Laboratory 138 applies their digital signature to verify the authenticity of uploaded results. Information validator 214 is an algorithm that is invoked by certificate engine 212 to determine whether the necessary information has been collected to complete certificate 166, and whether the information includes the necessary digital signatures that prove authenticity of that information. System 100 may determine additional requirements prior to movement of an animal, such as other tests, vaccinations, certification statements, isolation statements, and other conditions.

Where multiple certificates are required for the movement of animal 149, certificate engine 212 automatically ensures the information for each certificate is complete, requesting additional information as necessary from one or more of owner 148, veterinarian 144 and laboratory 138. For example, different states may have different rules 160 and regulations 162 for movement of animal 149, wherein certificate engine 212 generates at least one certificate 166 to comply with the rules and regulations of the destination state, and if required, of each state involved in the movement of the animal. Where information is provided by a plurality of difference sources, e.g., owner 148, veterinarian 144, and laboratory 138, certificate engine 212 correlates received information and determine when procedure 164 is complete and certificate 166 may be produced.

Certificate producer 216 is an algorithm for generating certificate 166 based upon collected information. Certificate 166 may be provided in one or more formats, based upon request 174. In one embodiment, certificate producer 216 generates certificate 166 as a file in Adobe PDF format and sends the file to one or both of owner 148 and veterinarian 144. In another embodiment, certificate producer 216 generates certificate 166 in HTML format for displaying on a web page generated by web interface 104, for example. Certificate producer 216 may be configured to generate a representation of certificate 166 in any format requested by owner 148, veterinarian 144 and state officials 134, 190.

In one embodiment, requirement interpreter 210, certificate engine 212, information validator 214, and certificate producer 216 form part of a single software package for automatically interpreting rules 160 and regulations 162, collecting needed information, and producing certificate 166, that accurately meets animal movement requirements. Where information stored for an identified animal is already present within database 102 (e.g., within animal records 242 and/or test results 244), information validator 214 determines whether that information is valid for use with certificate 166, wherein certain steps of procedure 164 may be automatically completed by system 100 without requiring additional information. For example, if a certificate has recently been requested for a particular animal, and test results for tests performed on that animal are still valid, information validator 214 may complete one or more steps of procedure 164 using that information, thereby omitting unnecessary tests on the animal and omitting collection of information already available within database 102. In one embodiment, system 100 collects information concurrently from each information source. For example, certificate engine 212 may interact with owner 148, veterinarian 144 and laboratory 138 concurrently to collect required information, initiate tests, and collect test results.

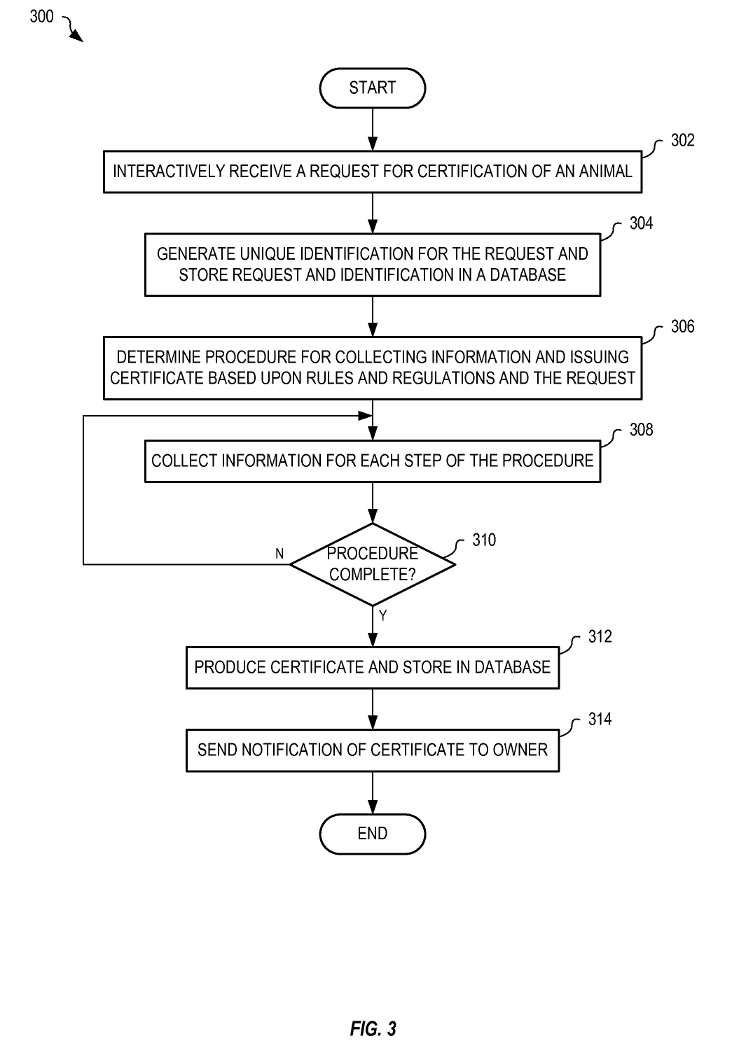

FIG. 3 is a flowchart illustrating one exemplary method 300 for storing and presenting animal certification information. Method 300 is implemented for example as machine executable instructions within software 290 of system 100, as shown in FIG. 2, and in particular within one or more of requirement interpreter 210, certificate engine 212, information validator 214, and certificate producer 216.

In step 302, method 300 interactively receives a request for certification of an animal. In one example of step 302, owner 148 uses browser 150 to interact with system 100, via Internet 120 and web interface 104, to request certification for moving animal 149 (e.g., a horse) from the owner's stable in Iowa to a show arena in Colorado. In another example of step 302, owner 148 interacts with web interface 104 to select animal 149 from animal records 242 of database 102, and then enters desired movement requirements including the starting location and the destination. In another example of step 302, veterinarian 144 selects owner 148 from a list of owners within system 100, selects animal 149 from a list of animal belonging to owner 148, and then enters addresses for the starting location and the destination. In step 304, method 300 generates a unique identification (e.g., a request number), forms a request including the information received in step 302, and stores the request and identification in a database. In one example of step 304, web interface 104 stores, within database 102, the received information within as request 174 in association with a generated unique identifier. System 100 may be integrated with multiple veterinary practice management, laboratory, and other, systems that allow for easy access to data within system 100 and allows requirements to be easily added and/or modified for certification processes.

In step 306, method 300 determines a procedure for collecting information and issuing a certificate based upon the rules and regulations and the request. In one example of step 306, requirement interpreter 210 processes rules 160 and regulations 162 to determine procedure 164 based upon the type of animal identified, the start location, and the destination defined within request 174. For example, procedure 164 includes a plurality of steps for collecting information to fulfill certificate 166, wherein each step defines needed information for at least a portion of certificate 166.

In one embodiment, where an entry permit is required by a destination (and/or transited) state, system 100 collects information (e.g., from one or more of owner 148, veterinarian 144, and laboratory 138) as required by the entry permit. For example, system 100 may include an interactive module that asks questions of owner 148, veterinarian 144, and/or laboratory 138 to verify that conditions have been met for the animal species, purpose of movement, state of origin, and other requirements of the entry permit. Once sufficient information has been collected, system 100 may allow owner 148 to print one or both of the entry permit and an OCVI certificate, while submitting the entry permit and OCVI directly to the states of export and import.

In step 308, method 300 collects information for each step of the procedure. In one example of step 308, certificate engine 212 interacts, via web interface 104, with one or more of owner 148, veterinarian 144, and laboratory 138 to collect animal identification information, movement information, test results, and any other needed information specific to certificate 166.

Step 310 is a decision. If, in step 310, method 300 determines that procedure 164 is complete, method 300 continues with step 312; otherwise method 300 continues with step 308. In one example of step 310, certificate engine 212 invokes information validator 214 to determine whether collected information is sufficient for issuing certificate 166 based upon rules 160, regulations 162 (e.g., vaccination requirements), request 174, animal records 242, and test results 244.

In step 312, method 300 produces a certificate based upon the collected information and stores the certificate in the database. In one example of step 312, certificate producer 216 is invoked to generate certificate 166 that conforms to rules 160 and regulations 162 for the movement of animal 149 based upon request 174, animal records 242, and test results 244. Certificate 166 is stored within database 102 and may include digital signatures that indicate authenticity of the certificate.

In step 314, method 300 sends notification of the certificate to the owner. In one example of step 314, certificate producer 216 sends a notification (e.g., one or more of a text message, an email message, an automated phone call, QR code, barcode, and other electronic means) to one or both of owner 148 and veterinarian 144 that certificate 166 is ready for download from system 100. In another example, certificate producer 216 sends an email 156 containing a digital representation (e.g., in PDF format) of certificate 166 to owner 148. In another example, system 100 notifies one or both of owner 148 and veterinarian 144 when they next login to system 100 using browsers 150 and 146, respectively.

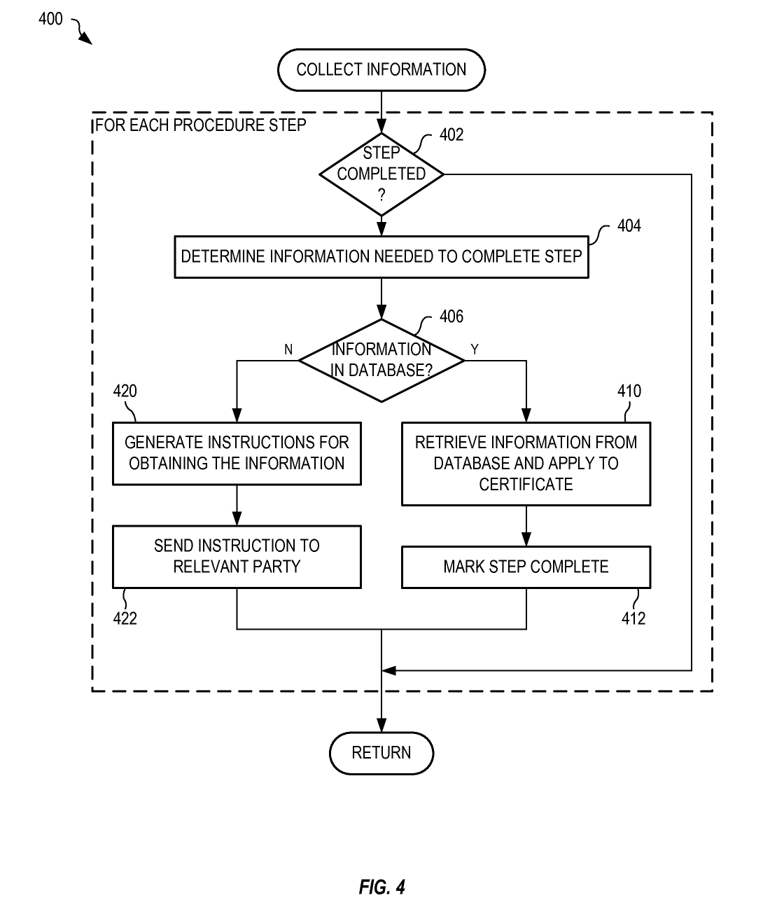

FIG. 4 is a flowchart illustrating one exemplary method 400 for collecting information for step 308 of method 300, FIG. 3. Method 400 is implemented for example as machine executable instructions within certificate engine 212 of system 100. Steps 402 through 442 are repeated for each step of procedure 164. Method 400 may be invoked each time information is received for, and associated with, request 174. That is, method 400 may not run continuously and wait for information to be sent to system 100, rather, method 400 is invoked for a particular request when information associated with that request is received by system 100. In an alternate embodiment, method 400 is invoked periodically to apply information received by system 100 to each appropriate request 174.

Step 402 is a decision. If, in step 402, method 400 determines that the current step is complete, method 400 continues with the next step of procedure 164 at decision 402; otherwise method 400 continues with step 404.

In step 404, method 400 determines the information needed to complete the current step of procedure 164. In one example of step 404, certificate engine 212 determines the information needed for certificate 166 from the current step of procedure 164. Step 406 is a decision. If, in step 406, method 400 determined that the information required for the current step of procedure 164 is within database 102, method 400 continues with step 410; otherwise method 400 continues with step 420.

In step 410, method 400 retrieves information from the database and applies it to the certificate. In one example of step 410, certificate engine 212 searches one or more of request 174, animal records 242, and test results 244 and retrieves information required for the current step of procedure 164 and applied the information to certificate 166. In step 412, method 400 marks the current step of procedure 164 as complete. In one example of step 412, certificate engine 212 sets a flag to indicate that the current step of procedure 164 is completed. Method 400 then continues with step 402 and the next step of procedure 164.

In step 420, method 400 generates instructions for obtaining the information needed for the current step of procedure 164. In one example of step 420, certificate engine 212 asks veterinarian 144 to select a laboratory for testing a blood sample. In another example of step 420, certificate engine 212 generates instructions for veterinarian 144 to collect a blood sample 142 from animal 149, generates a completed laboratory submittal form 143, and instructs the veterinarian to send the sample with submittal form 143 to laboratory 138. In step 422, method 400 sends the instructions of step 420 to the relevant party. In one example of step 422, certificate engine 212 sends the lab submittal form 143 and instructions generated in step 420 to veterinarian 144. Method 400 then continues with step 402 and the next step of procedure 164.

For each step of procedure 164, method 400 requests and/or collects information needed to complete certificate 166. Where information cannot be collected immediately, once the instructions are generated and sent, method 400 proceeds with the next step of procedure 164. When information is received within system 100, method 400 may be invoked to automatically apply the received information to one or more certificates 166. For example, received information includes an identifier that allows method 400 to apply the information to the appropriate request 174 and/or certificate 166. For example, laboratory 138 may enter, or select, the unique request identifier entered automatically by system 100 onto the submitted lab submittal form 143 when entering test results into system 100 using browser 140. For example, system 100 generates a tube number that is unique for each lab submission (see bottom portion of EIA certificate), or identifies a series of test specimen IDs to a group of animals.

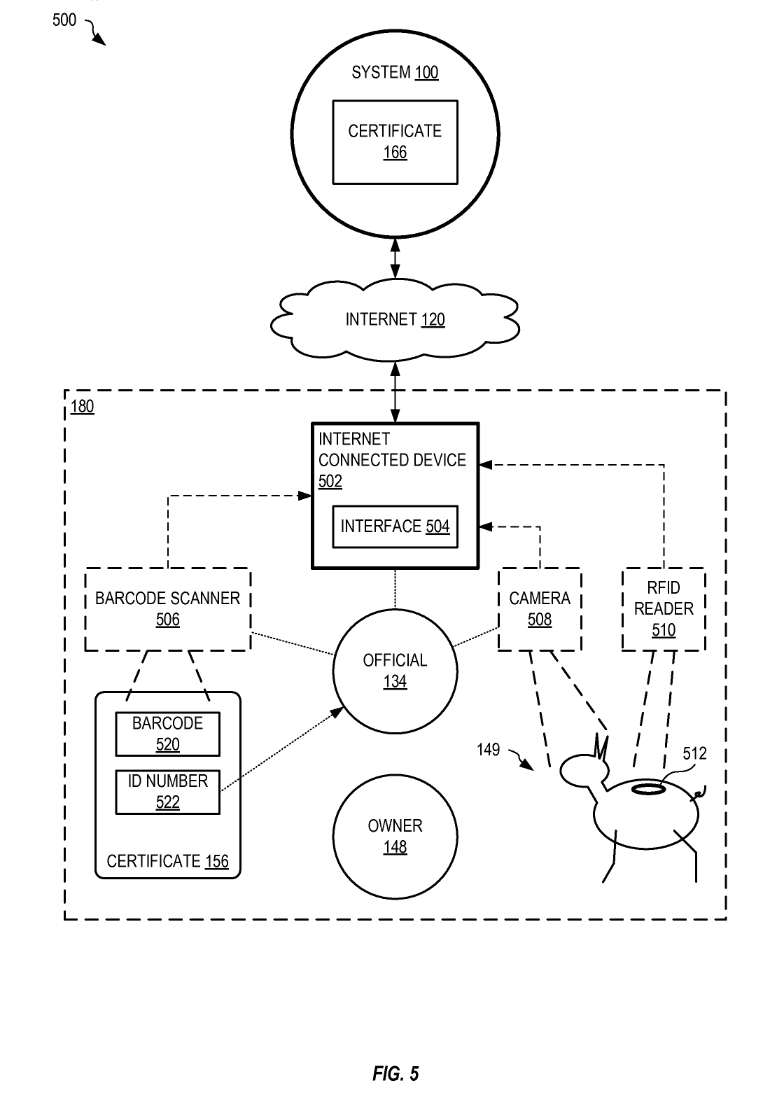

FIG. 5 is a schematic diagram illustrating exemplary use of system 100 to verify authenticity of certificate 166 for an animal passing through a control point 182. Control point 182 is for example at a state border, or an entrance to a stock show. Official 134 verifies that animal 149 being transported by owner 148 has appropriate certification for passing control point 182. In prior systems, official 134 would examine a paper copy of certificate 166 and compare the information entered on the certificate to animal 149, trusting that the signatures of veterinarian 144 and laboratory 138 on the paper copy of certificate 166 indicate the authenticity of the document.

By using system 100, official 134 may authenticate the presented certificate within system 100 and verify that the animal presented at control point 182 is the certified animal. In one example of operation, official 134 interacts with a user interface 504 of an internet connected device 502 to enter an identification number 522 of a presented certificate 166 or scans an electronic image (barcode, QR code, etc.) using a scanner 136. Device 502 sends the entered ID number 522 to system 100 via Internet 120 and web interface 104. System 100 retrieves certificate 166 using ID number 522 and sends an indication of authenticity and validity of certificate 166 and identifying information of animal 149 back to device 502, where the indication and identifying information is displayed on interface 504. If the indication indicates that certificate 166 is not valid, animal 149 is refused entry. If the indication indicates that certificate 166 is valid, official 134 then compared the identifying features displayed on interface 504 with those of animal 149. If official 134 determines that animal 149 matches the displayed identifying features, the animal is allowed to pass control point 182. If official determines that animal 149 does not match the displayed identifying features, animal 149 is refused entry.

With system 100, certificate 166 need not be printed on paper, but could be displayed on a mobile device of owner 148, for example, since control is based upon a stored copy of certificate 166 within system 100. In one embodiment, a presented copy of certificate 166 includes a barcode 520 representing ID number 522, wherein official 134 utilizes a barcode scanner 506 to read barcode 520 and automatically retrieve an indication of authenticity, validity, and identifying features of animal 149 from system 100.

In another embodiment, a camera 508 captures one or more images of animal 149 and sends these images to system 100 via device 502. System 100 then compares the images with identifying images of animals stored within database 102 to determine the identity of animal 149, and returns an indication of authenticity and validity of an associated certificate 166, together with identifying features of animal 149 for display on interface 504. Thus, system 100 automatically retrieves valid certificates for animals imaged by camera 508.

In another embodiment, an RFID reader 510 reads an ID number from an RFID transponder 512 implanted within animal 149 or affixed to a tag device attached to animal 149 and transfers this ID number to system 100 via device 502, Internet 120, and web interface 104. System 100 then identifies animal 149 and returns an indication of authenticity and validity of an associated certificate 166, together with identifying features of animal 149 for display on interface 504. In this embodiment, system 100 includes a table that associates implanted RFID tag numbers with an identity of the implanted animal, thereby allowing automatic animal identification and verification of associated certificates.

In one embodiment, device 502 includes one or more of scanner 506, camera 508, and RFID reader 510. For example, camera 508 may be used to scan an animal's iris or retina to identify and/or record an identity for the animal. Device 502 may include other analyzers, such as a DNA test profiler, for identifying a particular animal. Device 502 is for example a smart phone that includes a camera, has connectivity to Internet 120, and executes an application that interfaces with web interface 104 of system 100, wherein the smart phone application captures images of barcode 520, ID number 522, and/or animal 149 for processing within system 100 to determine certificate 166. Device 502 may be implemented with other types of camera and/or electronic instrument for identifying animals and cooperating with system 100 without departing from the scope hereof.

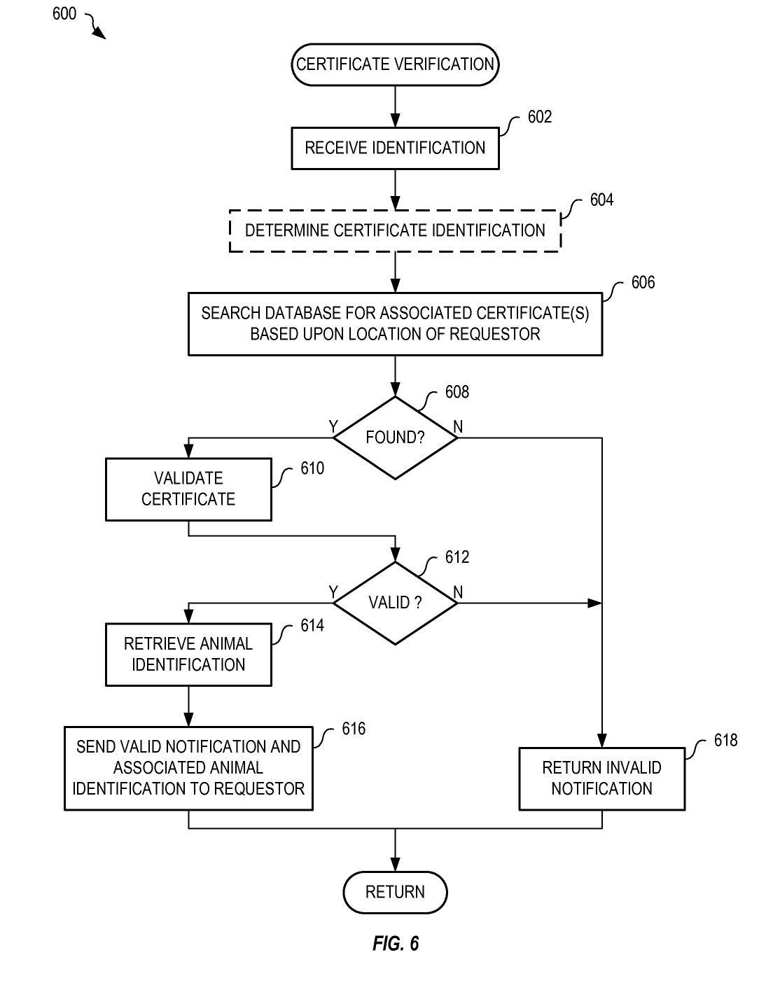

FIG. 6 is a flowchart illustrating one exemplary method 600 for validating an identified certificate within system 100. Method 600 is implemented for example within certificate validator 218 and allows officials (e.g., state official 134, and other parties) to validate certificates presented for animals (e.g., animals being moved, sold, slaughtered, and so on). In step 602, method 600 receives identification for retrieving a certificate. In one example of step 602, certificate validator 218 receives, via Internet 120 and web interface 104, an identification scanned from barcode 520 of the presented copy of certificate 166 by device 502 using scanner 506. In another example of step 602, certificate validator 218 receives, via Internet 120 and web interface 104, an RFID tag number of animal 149 scanned by device 502 using RFID reader 510. Device 502 may provide other information to certificate validator 218 such as one or more of an iris or retina scan, a DNA test profile, a QR code scan, a barcode scan, and so on. Step 604 is optional. If the identification received in step 602 is for a certificate (e.g., ID number 522 of certificate 166), step 604 is omitted; if the identification received in step 602 is for an animal, in step 604, method 400 determines at least one associated certificate identifier for the identified animal by searching the database. In one example of step 604, certificate validator 218 searches database 102 to determine identification of certificate 166 associated with animal 149 identified by the identification received in step 602. At remote access sites, such as trail rides, shows, auctions, and other such events, device 502 is implemented as a portable device with wireless access to system 100 via Internet 120, for example.

In step 606, method 600 searches the database for at least one certificate having the received identification of step 602 or the determined identification of step 604. In one example of step 606, certificate validator 218 searches database 102 to retrieve information of certificate 166 identified by ID number 522 received in step 602. In another example of step 606, certificate validator 218 searches database 102 to retrieve information of certificate 166 identified in association with animal 149 in step 604.

Step 608 is a decision. If, in step 608, method 600 determines that the certificate was found in the database, method 600 continues with step 610; otherwise method 600 continues with step 618.

In step 610, method 600 validates the retrieved certificate. In one example of step 610, certificate validator 218 invokes information validator 214 to re-validate information of certificate 166, wherein information validator 214 verifies that the certificate is still valid (i.e., has not expired or been withdrawn).

Step 612 is a decision. If, in step 612, method 600 determines that the identified certificate is valid, method 600 continues with step 614; otherwise, method 600 continues with step 618.

In step 614, method 600 retrieves animal identification information associated with the certificate. In one example of step 614, certificate validator 218 retrieves identification information for animal 149 from animal records 242, where animal 149 is associated with the retrieved information of step 606. In step 616, method 600 sends a valid notification and associated and identification to the requestor. In one example of step 616, certificate validator 218 sends a positive indication that the identified certificate is valid, and also sends identification information of the associated animal to allow the requestor to verify that the presented certificate is for the presented animal. Method 600 then terminates. For example, the identification information, optionally including images of the animal, is displayed on interface 504 of device 502 allowing official 134 to verify that animal 149 matches the information on certificate 166.

In step 618, method 600 sends an invalid notification to the requestor. In one example of step 618, certificate validator 218 sends a negative indication to device 502, wherein device 502 indicates (e.g., using interface 504 to make and noise and of display a negative indication) to official 134 that the presented certificate is not valid.

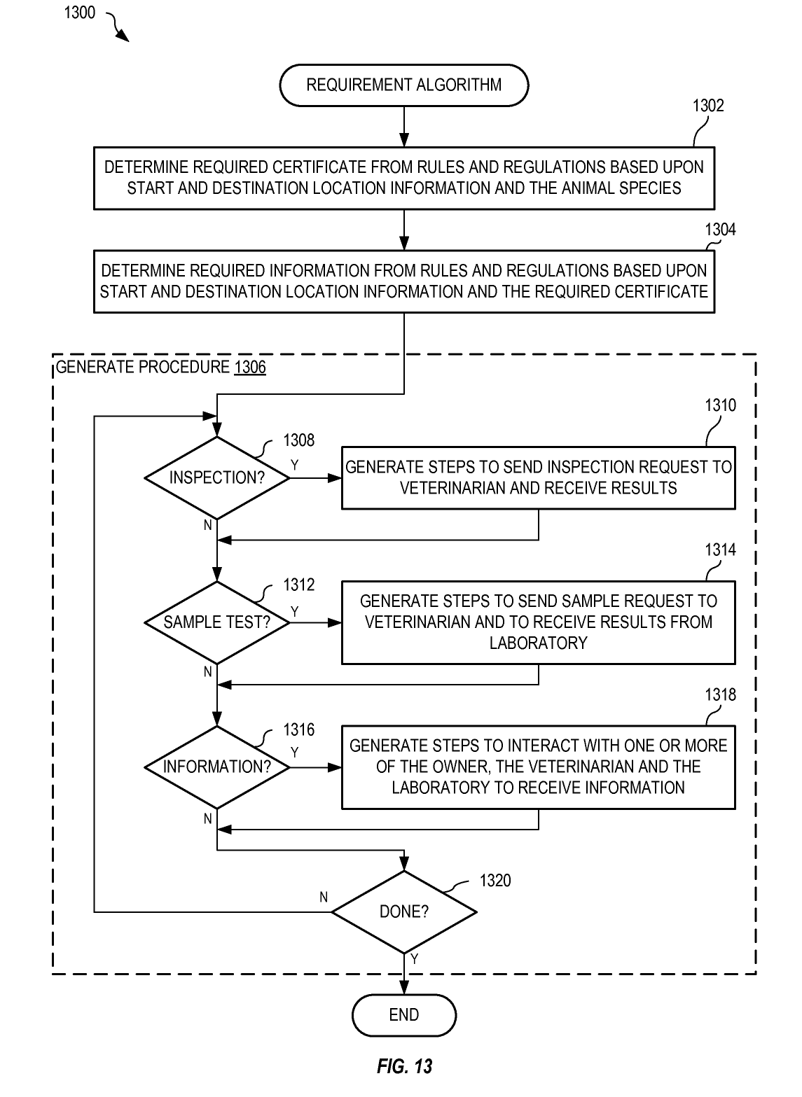

FIG. 13 shows one exemplary method 1300 for generating procedure 164 for collecting required information for certificate 166 of FIGS. 1 and 2. Method 1300 is implemented within the algorithm of requirement interpreter 210 of system 100, for example. Method 1300 generates procedure 164 by automatically determining, from rules 160, certificates required for request 174. For example, where request 174 is a request for a certificate to move animal 149 from a first state to a second state, rules 160 and regulations 162 for each of the first and second states define the required certificates 166 and information to complete the certificates.

In step 1302, method 1300 determines the required certificate from rules and regulations based upon start and end location information and the animal species. In one example of step 1302, requirement interpreter 210 searches rules 160 and regulations 162 to determine certificate requirements associated with movement of animal 149 between the first and second locations. In one embodiment, rules 160 and regulations 162 are entered (e.g., by state veterinarian 130) in a format that defines certification requirements for each of the first and second locations based upon the type of animal 149. In step 1304, method 1300 determines required information from rules and regulations based upon start and destination location information and the required certificate. In one example of step 1304, requirement interpreter 210 searches rules 160 and regulations 162 to determine required information for certificate 166 based upon the type of certificate, and the start and end locations. For example, based upon the end location, rules 160 and regulation 162 are searched to determine whether veterinary inspections and blood sample tests are required and determines other information (e.g., details of owner 148, veterinarian 144, laboratory 138, and animal 149) required to complete certificate 166.

Steps 1308 through 1320 repeat for each data item and/or action to generate procedure 164, and indicated by dashed box 1306. Each added step and/or procedure 164 is associated with certificate 166. Step 1308 is a decision. If, in step 1308, method 1300 determines that the next data item requires inspection of the animal by an accredited veterinarian, method continues with step 1310; otherwise method 1300 continues with step 1312. In step 1310, method 1300 generates steps to send an inspection request to an accredited veterinarian and to receive results of the inspection from the veterinarian. In one example of step 1310, requirement interpreter 210 adds a step of “send an inspection request of animal 149 to veterinary 144” to procedure 164, and then adds a step of “receive inspection results from veterinary 144” to procedure 164.

Step 1312 is a decision. If, in step 1312, method 1300 determines that the next data item requires that a sample be tested, method 1300 continues with step 1314; otherwise method continues with step 1316. In step 1314, method 1300 generates steps to send a sample request to an approved veterinary laboratory for the test and test type required and to receive results from an accredited laboratory. In one example of step 1314, requirement interpreter 210 adds a step of “send sample request to veterinarian 144” and adds a step of “receive test results from laboratory 138” to procedure 164.

Step 1316 is a decision. If, in step 1312, method 1300 determines that the next data item requires additional information, then method 1300 continues with step 1318; otherwise method 1300 continues with step 1320. In step 1318, method 1300 generates steps to interact with one or more of the state and/or federal animal health official, the owner, the veterinarian, and the laboratory to receive the additional information. In one example of step 1318, requirement interpreter 210 adds a step of “interact with owner 148 to receive home address of the owner” to procedure 164. In another example of step 1318, requirement interpreter 210 adds a step of “interact with veterinarian 144 to receive digital signature of the veterinarian” to procedure 164.

Step 1320 is a decision. If, in step 1320, method 1300 determines that steps have been generated for all data items, method 1300 terminates; otherwise method 1300 continues with step 1308.

Rules 160 and regulations 162 may be configured to facilitate searching by method 1300 of FIG. 13, and are maintained by authorized officials (e.g., state veterinarian 130, state official 190) that update rules 160 and regulations 162, wherein certificate 166 is generated to confirm to these latest rules and regulations.

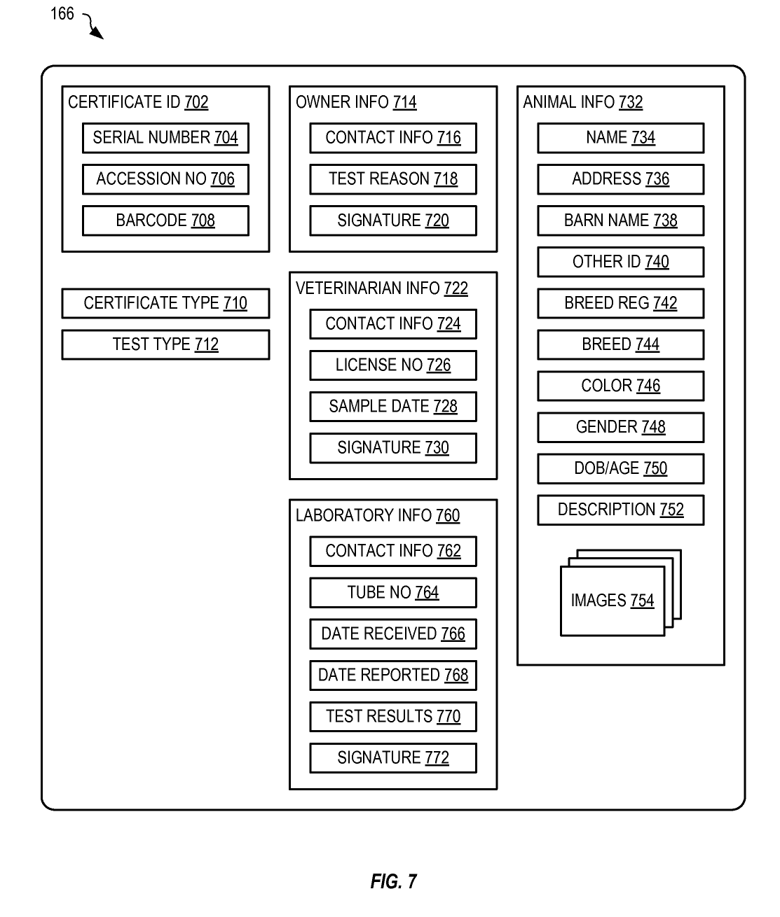

FIG. 7 is a schematic showing exemplary detail of certificate 166. Certificate 166 has a certificate identifier 702 that uniquely identifies certificate 166, owner information 714 that provides contact information of the animal owner (e.g., owner 148), veterinarian information 722 the provides information of the certified veterinarian (e.g., veterinarian 144) collecting a sample (e.g., sample 142) from the animal, animal information 732 that provides information of the animal (e.g., animal 149) being certified, and laboratory information 760 that provides information of the laboratory performing test on the sample.

Certificate identifier 702 includes a serial number 704 associated with the type of certificate 166, an accession number 706 that is unique, and optionally a bar code 708 (or QR code or other machine readable format) that is also unique and may represent accession number 706. Certificate identifier 702 is for example stored within database 102 in association with one or more of: animal records 242 (i.e., animal 149), owner 148, and veterinarian 144. A certificate type 710 defines the type (e.g., OCVI, Online EIA, and eVRx®) of certificate 166, and a test type 712 defines the type of test to be performed on the sample taken from the animal. For example, EIA/Coggins certificates require an EIA test; OCVI certificates may require one or more tests, whereas tracking of veterinary applied medications may not require a test at all.

Owner information 714 includes contact information 716 (e.g., name, address and telephone numbers), test reason 718 (e.g., a reason for the test, such as annual, movement, and so on), and a signature 720 (e.g., a digital signature) of the owner indicating that the owner believes that owner information 714 and animal information 732 is correct.

Veterinarian information 722 includes contact information 724 (e.g., name, address and telephone numbers), a license number 726 (e.g., a federal accreditation number and/or a veterinary license number), a sample date 728 indicating a date when a sample (e.g., sample 142) was taken from the animal (e.g., animal 149), and a signature 730 (e.g., a digital signature from digital signatures 246) indicating that the veterinarian (e.g., veterinarian 144) believes entered information of animal information 732 and veterinarian information 722 is correct.

Animal information 732 describes the certified animal and includes a name 734 (e.g., a registered name of the animal), an address 736 (e.g., a stable address, official premises identification number, etc.), a barn name 738 (e.g., a nickname of the animal), other identifying names or numbers 740, breed registration 742 (e.g., a number identifying the breed of the animal), a breed 744 (e.g., the commonly used name of the breed), a color 746 (e.g., coat color of the animal), a gender 748 (e.g., one of male, female, gelding, and neuter), date of birth or age 750 (e.g., the date the animal was birthed), description 752 (e.g., a narrative description of the animal's distinguishing features, such as color, markings, brand(s), and so on), and images 754 (e.g., images taken of the animal). Animal information 732 may also include iris or retina scan data, DNA test profile data, QR code data, barcode data, electronic or visual identification device numbers, and other such data for identifying the animal.

Laboratory information 760 includes contact information 762 (e.g., name, address and telephone numbers), one or more tube numbers 764 (e.g., a uniquely identifying number identifying a sample within the laboratory), date received 766, date reported 768 (e.g., the date the test results are reported), test results 770 (e.g., positive or negative), and a signature 772 (e.g., a digital signature indicating that the test results are entered by a certified laboratory technician).

Certain information of certificate 166 may change for different animals and different tests without departing from the scope hereof.

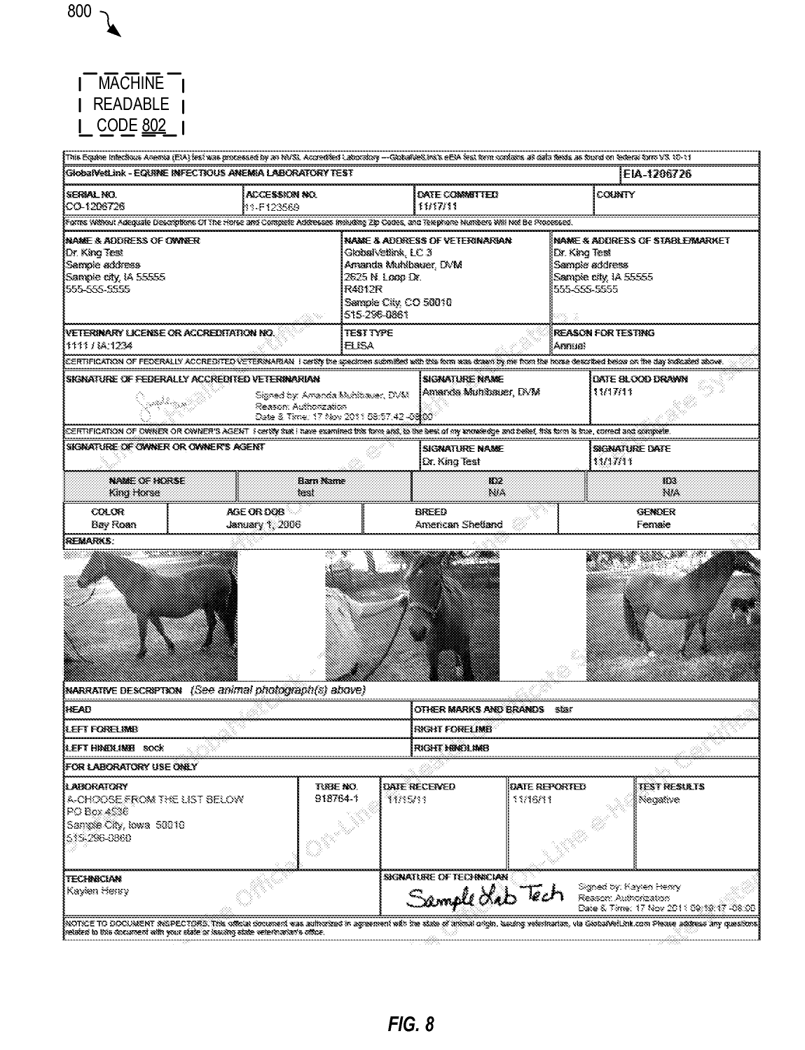

FIG. 8 is an image 800 of one exemplary certificate 166 produced by system 100 of FIG. 1 and printed by owner 148 using printer 152 for example. Optionally, image 800 may include a machine readable code 802 (e.g., a barcode or a, QR code) to facilitate verification of certificate 166 at a control location, where machine readable code 802 is scanned to determine certificate ID number 522 of certificate 166 for verification within system 100.

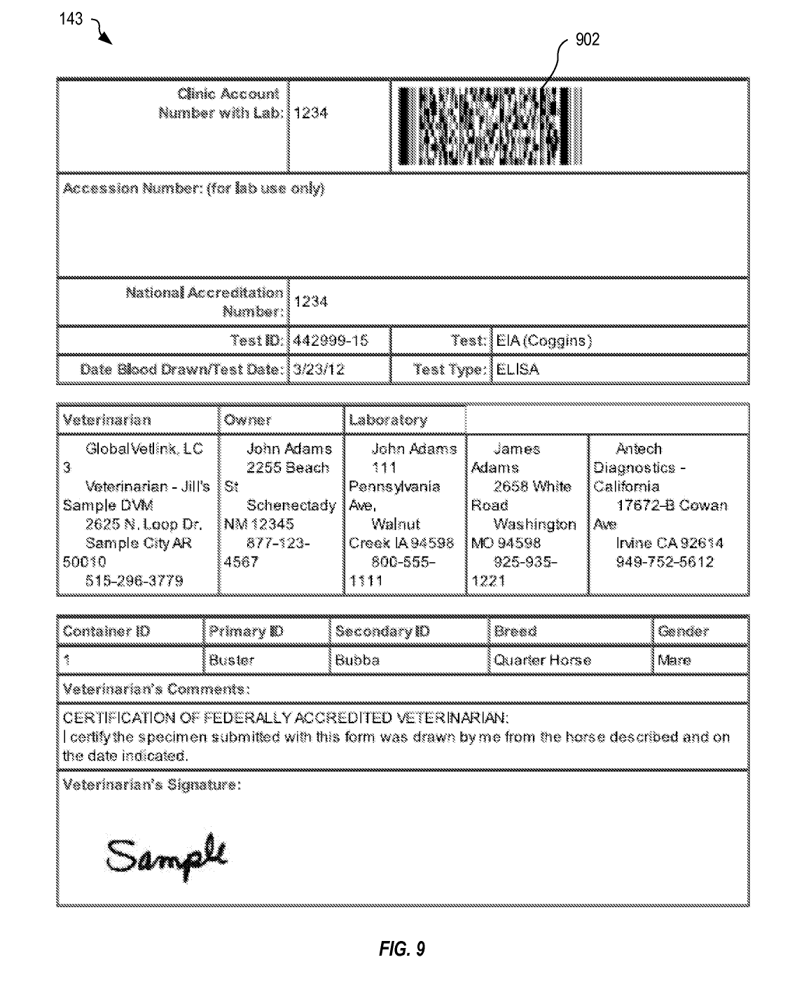

FIG. 9 shows one exemplary laboratory submittal form 143 with a machine readable code 902 that facilitates tracking of blood sample 142, sent by veterinarian 144 to laboratory 138, within system 100 of FIGS. 1 and 2.

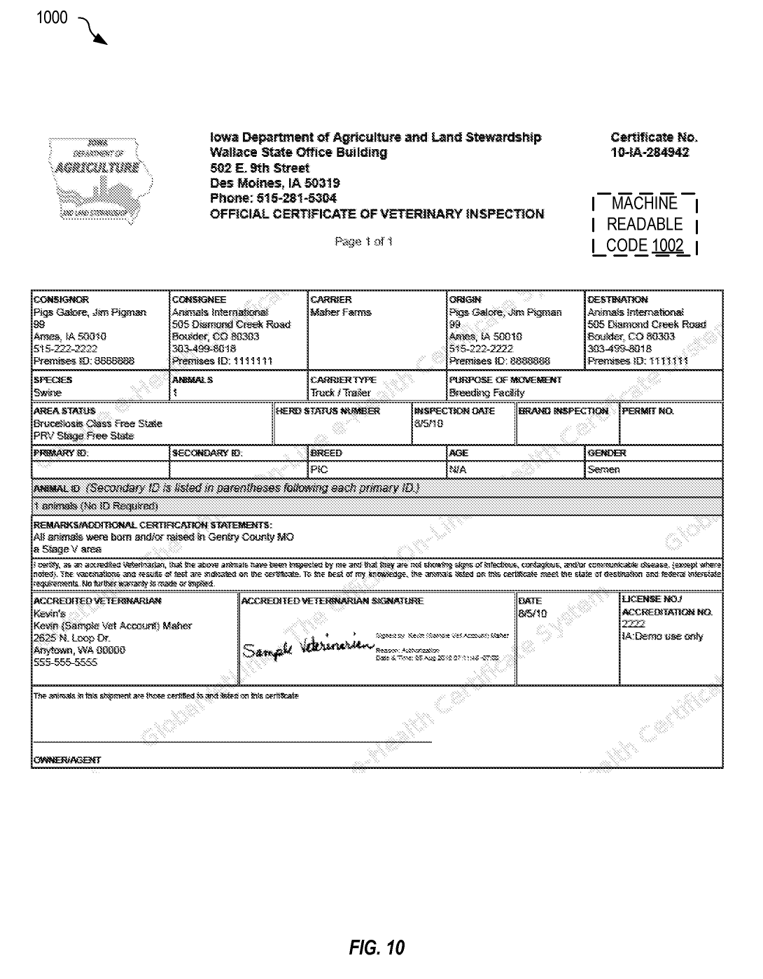

FIG. 10 shows one exemplary veterinary inspection certificate 1000 that is generated by system 100 of FIGS. 1 and 2 to indicate inspection of animal 149 by certified veterinarian 144. Certificate 1000 may include a machine readable code 1002 (e.g., a barcode or a, QR code) that facilitates automatic validation of certificate 1000 within system 100. For example, an official may use a device to scan machine readable code 1002 to determine a certificate ID of certificate 1000, send the certificate ID to system 100 (e.g., via Internet 120) and receive, substantially in real time, an indication of the validity of certificate 1000.

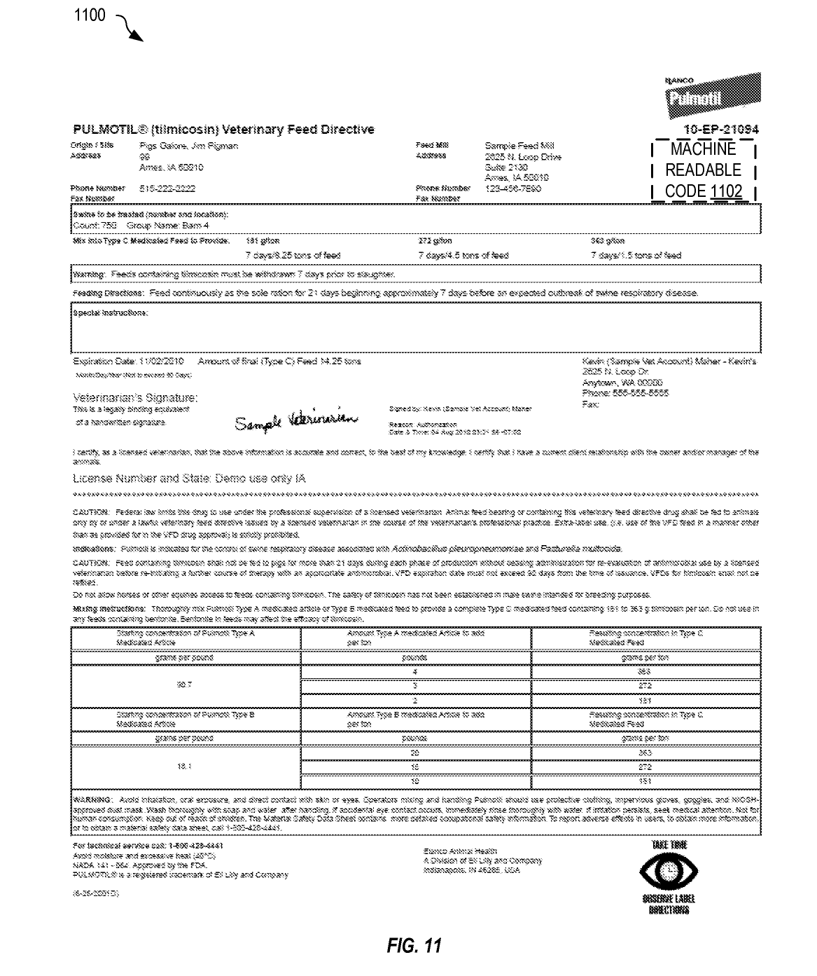

FIG. 11 shows one exemplary prescription certificate 1100 for use of medication within animal feed, as tracked by system 100 of FIGS. 1 and 2. Certificate 1100 may include a machine readable code 1102 (e.g., a barcode or a, QR code) that facilitates automatic validation of certificate 1100 within system 100.

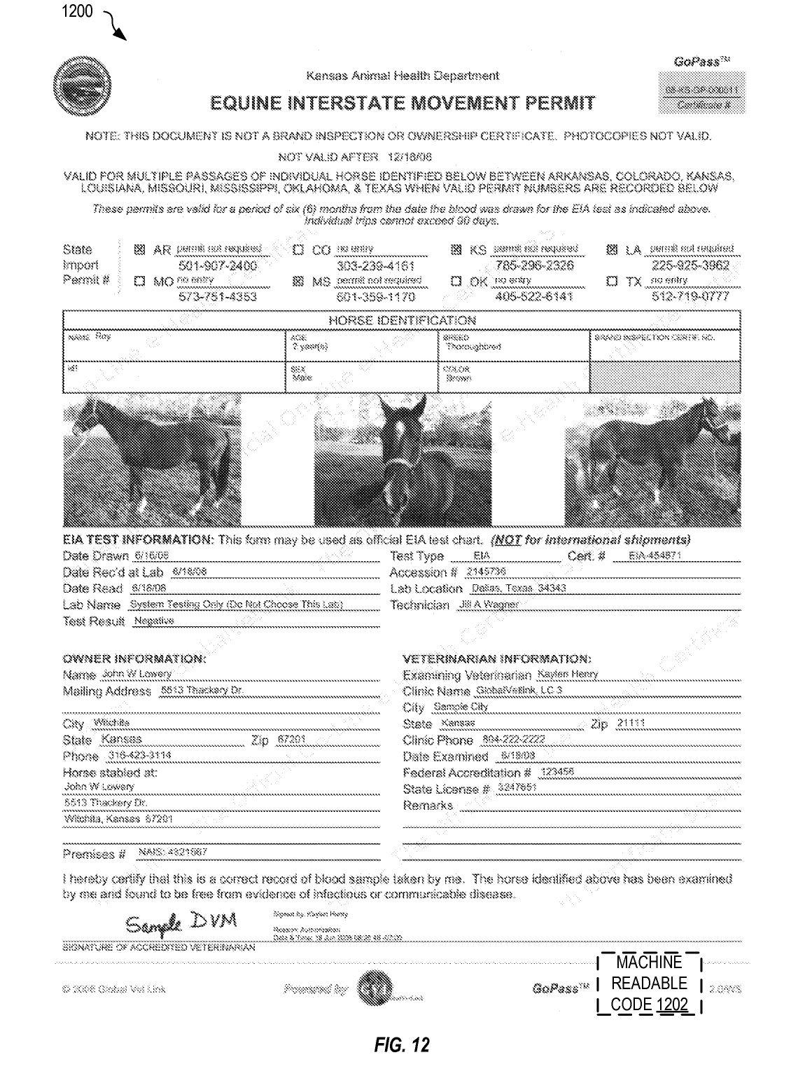

FIG. 12 shows one exemplary certificate 1200 generated by system 100 of FIGS. 1 and 2 as required to move a horse (e.g., animal 149) between states. Certificate 1200 may include a machine readable code 1202 (e.g., a barcode or a, QR code) to determine a certificate ID of certificate 1200, send the certificate ID to system 100 (e.g., via Internet 120) and receive, substantially in real time, an indication of the validity of certificate 1200. For example, an official at a state border may use a mobile device to scan code 1202, send a determined certificate ID to system 100, and receive, substantially in real-time, an indicate of validity of certificate 1200.

In one embodiment, system 100 may be used to perform additional checks wherein both the certificate ID number 522 and/or barcode information are verified against the RFID tag ID read from animal 149. System 100 may use other information (e.g., iris or retina scan, DNA test profile, and other types of tag or code) to validate the animals identity and validity of certificate 166.

In another embodiment, where presented animals each have an implanted or externally attached RFID tag, system 100 may cooperate with device 502 to automatically identify each presented animal and verify that the animal has a valid certificate.

In another embodiment, system 100 and device 502 cooperate to capture images (e.g., using camera 508 attached to, or incorporated within device 502) of presented animals, identify each presented animal based upon the captured images, and verify that each animal has an associated and valid certificate.

Predicting Effectiveness of Animal Treatments

Animal husbandry depends upon the skill and knowledge of the animal keeper to efficiently and successfully maintain the wellbeing of the animals. Conventional systems for supporting this endeavor exhibit the following problems:
1) Lacking a complete herd health solution to monitor and detect disease, with traceability tools, including treatments such as antibiotic usage, vaccinations, and related treatment interventions.
2) Insufficient tools to capture and collect real-time data to consistently monitor and analyze disease prevalence and outcomes.
3) Minimal visibility to aggregate data for emerging disease trends as well as judicious use of antibiotics and related animal health intervention strategies.
4) Difficulty tracking specific animals and/or groups due to inconsistent data and methods.

Conventional herd treatment typically utilizes a system or method of, when a disease is discovered, or has become prevalent within a herd (i.e., a plurality of animals together), administering a known treatment technique to the entire herd. Such administered techniques are known to include the addition of drugs or antibiotics to the herd's feed, water soluble additives into the herd water supply, or direct injection into each animal of the herd. The administration thus typically provides each animal of the herd with the same level of treatment. This “one size fits all” approach is less expensive than treating each animal individually, but it is also often ineffective in reducing the disease prevalence or eradicating a treatable condition among a herd, and for several reasons.

First, treatment of an entire herd generally will only consider the “typical” animal affected by the disease at issue. In reality, however, individual animals within a herd will vary widely from the “typical” animal. Receptivity to treatment can be greatly affected animal parameters such as the age, weight, species, genotype, class (e.g., racing pleasure, backyard, competition, food production, etc.), stage (e.g., “growing,” “finishing,” “reproductive,” “nursery” for production animals; “pre-weaned,” “weaned,” “growing” for racing animals; etc.), gender, geo-location, past health history, and/or season of the individual animals within the herd. Several of these animal parameters can also affect the significance of others of the parameters for the same herd. Conventional herd treatments, however, do not take such individual factors into consideration when treating a herd. These animal parameters are also important with respect how herd treatments will be administered. It may be more desirable to treat cows in a dairy herd more individually, whereas feeder cows (and similarly weaned pigs, or growing and finishing stage animals) maybe more economical to treat as a group. Horse herds tend to be smaller in number as well, and it is desirable to treat such smaller herds individually.

When conventional herd treatments are first administered, the herd is then monitored over time to decide whether the first treatment was effective. After some significant time has passed, the herd is retested for the disease at issue, or to verify whether the herd morbidity rate has increased. If the disease is still prevalent among the herd, or the morbidity rate has increased, the herd is retreated for the disease. The retreatment will typically be a re-administration of the first treatment at a higher dosage allowed by FDA approved labeling (if the treatment was drug-related) and/or for a longer duration than the first treatment. The herd will then be monitored again over time, and the process repeated if still ineffective. Thus, over time, this conventional method can prove very costly for repeated “trial and error” applications, and large portions of the herd can be lost over the weeks and months typically required for retreatment and monitoring. Portions of the herd can also be lost when the prescribed treatment may be effective for some of the animals more closely conforming to the “typical” animal, but not for other animals in the herd.

Second, the first chosen treatment may not even be effective in a particular herd, for the specific disease at issue, even though the treatment may be a well-known FDA-approved treatment for animals. As discussed above, animal parameters particular to the herd may render one FDA-approved treatment more effective than another for the animals of a particular herd. A herd can be lost to a disease, however, while the “trial and error” approach searches for the right treatment, and then the right dosage/duration of that treatment. This problem is less common for an individual animal being treated one-on-one by a skilled veterinarian, who can monitor an individual animal in a timely manner and adjust treatments quickly. This level of individual treatment, however, is physically impossible, and economically prohibited, for a herd of hundreds or thousands of animals.

According to the nonconventional embodiments described herein though, a statistically significant sample of the herd can be tested for a particular disease, and resultant lab results can be entered into the present system along with one or more of the animal parameters described above. Since some of the animal parameters may affect others of the parameters, the system will preferably enter two or more of the parameters along with the lab results of the statistically significant sample of the herd. The quantity of the herd that is considered “statistically significant” can be determined according to industry-recognized associations specializing in the particular type of animal at issue (e.g., American Association of Swine Veterinarians for swine). The present systems and methods may then factor together the lab results and animal parameters, and then determine an ideal treatment for the herd according to the parameters of the herd sample. The present inventor has discovered that this data-driven-decision making process of the system avoids the conventional “trial and error” method of herd treatment by using animal parameter data best suited to the particular herd being treated, and not just animals of the herd type.

The present embodiments thus represent a significantly advantageous herd treatment method over the conventional approach. The present embodiments also represent an even further significant advance over herd treatment, by the ability to further determine ideal treatment levels for individual animals within a herd, in addition to the improved determination of the ideal treatment of the entire herd. Once the system determines the ideal treatment to the particular herd using the data-driven decision tools of the present embodiments, the system may further specifically tailor dosage and treatment of individual animals within the herd according to the animal parameters of the individual animal.

For example, a herd of one thousand animals may only require one hundred individual members of the herd to be tested as a statistically significant sample, and an ideal treatment of the entire herd may be determined from the lab results and animal parameters of the one hundred member sample. Individual animals of the one thousand-member herd though, can vary greatly with respect to age, weight, season, genotypic differences, etc. The system may automatically recommend different treatment dosages/durations according to the animal parameters of each of the one thousand animals. This type of individual treatment approach is further greatly facilitated using the animal certification cataloguing systems and methods discussed above. All of the animal parameters for each individual of the herd can be entered into the system for the cataloguing purposes discussed above, yet fully utilized to customize treatment for the individual animals in cooperation with this animal treatment system and methods.

According to this nonconventional, significantly improved methodology, the system may approximate the ability to treat individual animals that a skilled veterinarian may accomplish one-on-one with an animal, but by only having to first measure the statistically significant number of the herd. In the example described immediately above, a veterinarian (or group) would have to test one thousand animals, and then treat and monitor one thousand animals, to give each animal one-on-one attention. According to the present embodiments, however, for the same example, only one hundred animals would need to be tested, and treatment of all one thousand animals would not require a skilled veterinarian to administer the tailored dosing of each animal. The present system thus further avoids the “one size fits all” approach, while keeping closer to the costs of treating an entire herd at once, but with a statistical success rate more approximate to the one-on-one approach of a skilled veterinarian with one animal. The tailored dosing of these embodiments can be made even further effective in cooperation with the nonconventional feed directive embodiments also described herein.

The present embodiments thus factor into the analytics of the treatment decision process significantly more data and automated decision processing than the conventional trial-and-error and one-size-fits-all conventional approaches. The system is based on a statistically significant diagnostic sample size of the population of animals from which the samples are drawn, and can both build a database of animal parameters for a particular disease, or later access such database once built. The process will then be based on test type selected for a particular prevalent disease among a herd population, and then submit the test results to a lab. The lab generated test result can then be compared in the database against a specific disease prevalence in group of the animal type with exhibiting the same relevant animal parameters within the statistical group. The system would compare this information to then recommend an ideal treatment for that type of animal, having the particular attributes of the same animal parameters, to produce a data-driven recommendation with a confidence of x %, where x is a number approximate to a confidence level achieved by one-on-one treatment of an individual animal by a skilled veterinarian. Resulting production performance data, including average daily gain, feed efficiency, morbidity, mortality, days to market, or reproductive performance, etc. can then be analyzed and stored to be indexed later for the future treatment requests.

System 100 is further extended to record information of managing and caring for animals such that data resulting from lab submission may be processed, together with production performance information, species and genotypic data, and previous treatment results to better predict which treatment has the highest probability of providing a positive impact on a particular animal and/or group of animals, using data of their specific production phase, species category, genotype, and environmental conditions.

This accumulated data would be a product of past diagnostic analysis/testing result data, visual observation data, production performance data, morbidity and mortality data, past treatments and treatment outcomes, that are derived by production system data that would be incorporated to model the treatment recommendation, by use of data that proves the effectiveness of past treatment(s) used to address the disease diagnosis. Treatments may include specific types of antibiotic uses, vaccination uses and related animal health treatments recommended by a veterinarian to their client.

The system validates the best treatment for the specific diagnosis while incorporating diagnostic data from the animal or group to be treated, and incorporates historical data from past treatments that occurred within that premises or animal location, including additional animal population's treatment and outcomes from a wider geographical sampling of live data, to further validate the treatment decision process, including specific components of the antibiotic or vaccination formula to be administered.

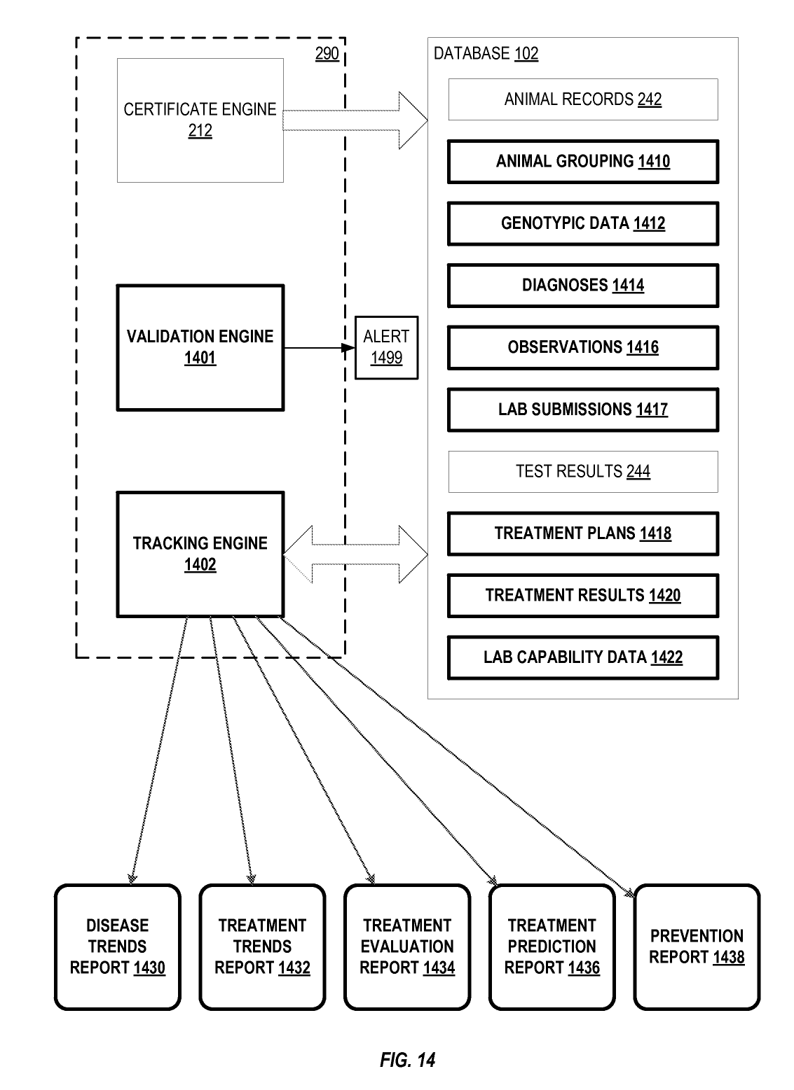

FIG. 14 shows further exemplary detail of software 290 and database 102 of system 100 of FIG. 1. Certificate engine 212 operates to collect information for storage within database 102, as described above. A tracking engine 1402 and certificate engine 212 cooperate to collect animal records 242, animal grouping 1410, genotypic data 1412, diagnoses 1414, observations 1416, lab submissions 1417, test results 244, treatment plans 1418, and treatment results 1420.

In one example of operation, a veterinarian (e.g., veterinarian 144) collects a specimen for analysis by a laboratory (e.g., laboratory 138). Tracking engine 1402 and/or certificate engine 212 records information of the laboratory submission within lab submissions 1417. The laboratory runs acceptable or approved tests to analyze the specimen and returns test results on one or more of the following: disease type or prevalence, genotype of animal, and genotype of disease and/or diagnosed agent(s). Genotypic data 1412 of one animal may be matched (e.g., using DNA sequencing and/or genetic markers) against genetic make-up of other animals within a given species and breed that show susceptibility/non-susceptibility to disease and/or where a particular treatment plan 1418 has been used in the past. The success of particular treatments on genetically similar animals may thereby be used to select ideal treatments. For example, system 100 may be used to diagnose and track Porcine Epidemic Diarrhea (PEDv) virus and Swine Enteric Coronavirus Diseases (SECD), such that prevalence and control of the disease may be easily determined and monitored. See for example: http://www.aphis.usda.gov/wps/portal/banner/help?1dmy&urile=wcm %3Apath %3A %2Faphis_content_library %2Fsa_our_focus %2Fsa_animal_health %2Fsa_animal_disease_information%2Fsa_swine_health,

A veterinarian may interact with system 100 via web interface 104 to enter certain observations and other animal information that is stored within observations 1416 in association with animal records 242. For example, the veterinarian and/or farm workers may measure and record one or more of body temperature, morbidity, mortality, respiration, animal and environment observations, production performance data (e.g., quantity of eggs, milk, body weight gain, meat produced), and other measurable growth or production metrics.

A veterinarian may specify one or more treatment plans 1418 for a particular animal based upon a determined diagnosis. Treatment plan 1418 may for example specify a prescription for application of a particular drug to the animal over time. Treatment plan 1418 may also specify a vaccine as a preventative treatment for the animal. Treatment plan 1418 may specify a feed treatment where a natural product or a medication is applied as a topical ration treatment or mixed into a feed ration of the animal. Treatment plan 1418 may specify a subcutaneous or topical treatment for application to skin/hide of the animal or other external or subcutaneous use. Treatment plan 1418 may specify an aerosol treatment that is to be inhaled by the animal. Treatment plan 1418 may specify a water treatment where one or more of medication, vitamin, mineral, and other similar substances, are delivered to the animal via application to the animals water source.

Tracking engine 1402 may interact with one or more external management systems (e.g., a production management software that manages production of specific animals) to receive information on each animal stored within animal records 242 and animal grouping 1410. For example, if the animal is production, the phase of the production (e.g., one or more of milking, feeding, growing, etc.) is stored within animal records 242. Production management software typically measures feed inputs, body weight growth and/or production data on egg, milk, meat production, and so on. Information received from the production management software may be used by tracking engine 1402 to evaluate treatments performed on the animals and to generate treatment results 1420. Each treatment result 1420 indicates the effectiveness of one treatment plan 1418 on one or more specific animals.

Each animal may have an individual ID and/or a group ID and any disease status (or prevalence), climatic and location conditions (e.g., average temp during period, coastal, plains, high plains, mountainous, etc.) may be stored. Additional data may be measured and entered for each animal, such as body temperature, morbidity, mortality, respiration, animal and environment observational information, production performance data (e.g., quantity of eggs, milk, meat produced), and other measurable growth or production metrics.

Tracking engine 1402 may also collect animal well-being data that is stored within observations 1416 for example. Such well-being data may include information of farm employees' certifications and that all (or an acceptable percentage of) animal handlers are adequately trained (e.g., a depth and/or type of training, of verifiable attributes of low stress handling, etc.), and confirmation that production data improved, worker behavior reduced animal and people injuries, and data validating animal well-being is adequately implemented and maintained at the farm level.

Tracking engine 1402 may process data stored within database 102 to generate one or more reports, including a disease trends report 1430, a treatment trends report 1432, a treatment evaluation report 1434, a treatment prediction report 1436, and a prevention report 1438.

Disease trends report 1430 is generated by tracking engine 1402 based upon results from testing of one or more of blood, serum, or other tissue submissions by a diagnostic laboratory and may include one or more of a diagnostic report of disease diagnosis, disease prevalence, genetic markers or DNA composition of the disease diagnosis, test titer (or related quantitative values) representing test result details that would help further analyze treatment option susceptibility.

Treatment trends report 1432 is generated by tracking engine 1402 based upon treatment plans 1418 and treatment results 1420 and may include a list of past treatments for a specific diagnosis and animal type, species, etc., and may include information on pathogen susceptibility to a specific drug, animal immune response, and/or disease prevalence change, based on specific treatments per diagnosis. Treatment results 1420 for a particular treatment plan 1418 may thereby be compared to determine likely effectiveness of that treatment plan on a similar animal (e.g., an animal of similar type, age, production stage, and so on). Similarly, treatment results 1420 for different treatment plans 1418 associated with treatment of a particular disease may be compared to determine an appropriate treatment plan for third animal based upon similarities between the animals and conditions.

Treatment evaluation report 1434 is generated by tracking engine 1402 based upon processing of production performance or animal health measurable data inputs such as animal temperature, morbidity, mortality, and basic performance metrics, and may include information on one or more of a pneumonia diagnosis of x in a specific animal population with given attributes response to specific treatments with x % efficacy, and performance measures indicated x % improvement in select production parameters (meat, milk, egg, weight gain, etc.,) and morbidity and mortality was reduced or not by x %.

Treatment prediction report 1436 is generated by tracking engine 1402 based upon treatment plans 1418 and treatment results 1420 by use of treatment x or y, against the animal or animal population in the system and includes information on estimated efficacy. For example, treatment prediction report may indicate that treatment x=estimated 95% efficacy in same set of animal attributes and cost based on production data=$x per animal or per group, and that treatment y=87% efficacy on similar with a cost factor of $n per animal group.

Prevention report 1438 is generated by tracking engine 1402 based upon specific disease quantitative values from test results 244 and their susceptibly to treatment plans 1418 (e.g., based upon treatment results 1420) and may include information on one or both of (a) reduction of disease x prevalence and (b) a ranking of suggested preventions or interventions strategies (e.g., specific vaccination type and RNA/DNA configuration, or antibiotic treatment administered at x age or production phase, produces the following top recommendation to prevent disease Y).

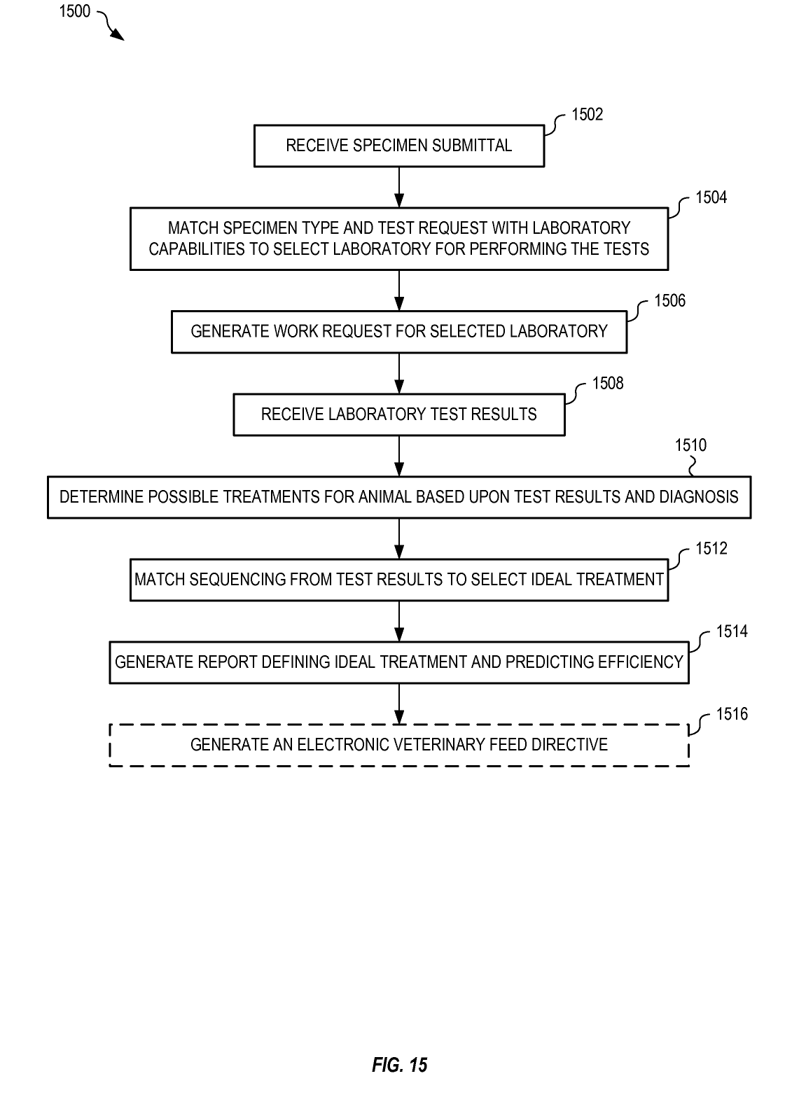

FIG. 15 shows one exemplary method 1500 for recommending an ideal treatment for an animal based upon test results from tests of a specimen collected from the animal. Method 1502 is implemented within tracking engine 1402 for example. In step 1502, method 1500 receives a specimen submittal. In one example of step 1502, a veterinarian collects a specimen from an animal and enters details into a submittal form of tracking engine 1402 via web interface 104. In step 1504, method 1500 matches the specimen type and test request(s) with laboratory capabilities to select a laboratory for performing the test. In one example of step 1504, tracking engine 1402 matches the specimen type and the test request(s) to capabilities stored within lab capability data 1422 to select an appropriate laboratory for performing the tests on the specimen. In step 1506, method 1500 generates a work request for the selected laboratory. In one example of step 1506, tracking engine 1402 generates and sends an electronic work order to the selected laboratory and outputs labeling information to identify and send the specimen to the selected laboratory. Examples of requested tests include: disease type and/or prevalence; standardized test; regulatory tests, genotype of disease; antimicrobial presence, antimicrobial resistance and analysis; antimicrobial resistance; and genetic analysis.

In step 1508, method 1508 receives the laboratory test results. In one example of step 1508, tracking engine 1402 receives an electronic communication containing the test results from the selected laboratory. In step 1510, method 1500 determines an appropriate treatment for the animal based upon test results. In one example of step 1510, tracking engine 1402 determines an antibiotic treatment, vaccination treatment or other treatment for the animal based upon the test results, animal records 242, genotypic data 1412, diagnoses 1414, observations 1416, treatment plans 1418, and treatment results 1420. That is, tracking engine 1402 utilizes stored data within database 102 to identify other animals having similar situations (e.g., one or more of animal type, age, production stage, environmental conditions, and so on), symptoms, identified diseases, etc. to identify and update a treatment plan 1418 that is the most likely to be successful in the specific treatment strategy for the animal or group of animals. In step 1512, method 1500 matches genetic markers (e.g., one or both of RNA and DNA sequences) from the test results to select an ideal treatment. In one example of step 1512, tracking engine 1402 matches genetic markers for the animal with stored genetic markers of other animals that have benefited from use of similar treatments to determine the most appropriate and effective treatment for the animal. In step 1514, method 1500 generates a report defining the ideal treatment. In one example of step 1514, tracking engine 1402 generates treatment evaluation report 1434 prioritizing the three most effective treatments for the animal, such as one or more of vaccine, antibiotic, or other treatment option(s). In another example of step 1514, tracking engine 1402 generates treatment prediction report 1436 containing predicted effectiveness of the treatment based upon effectiveness of the same or similar treatment of other similar animals.

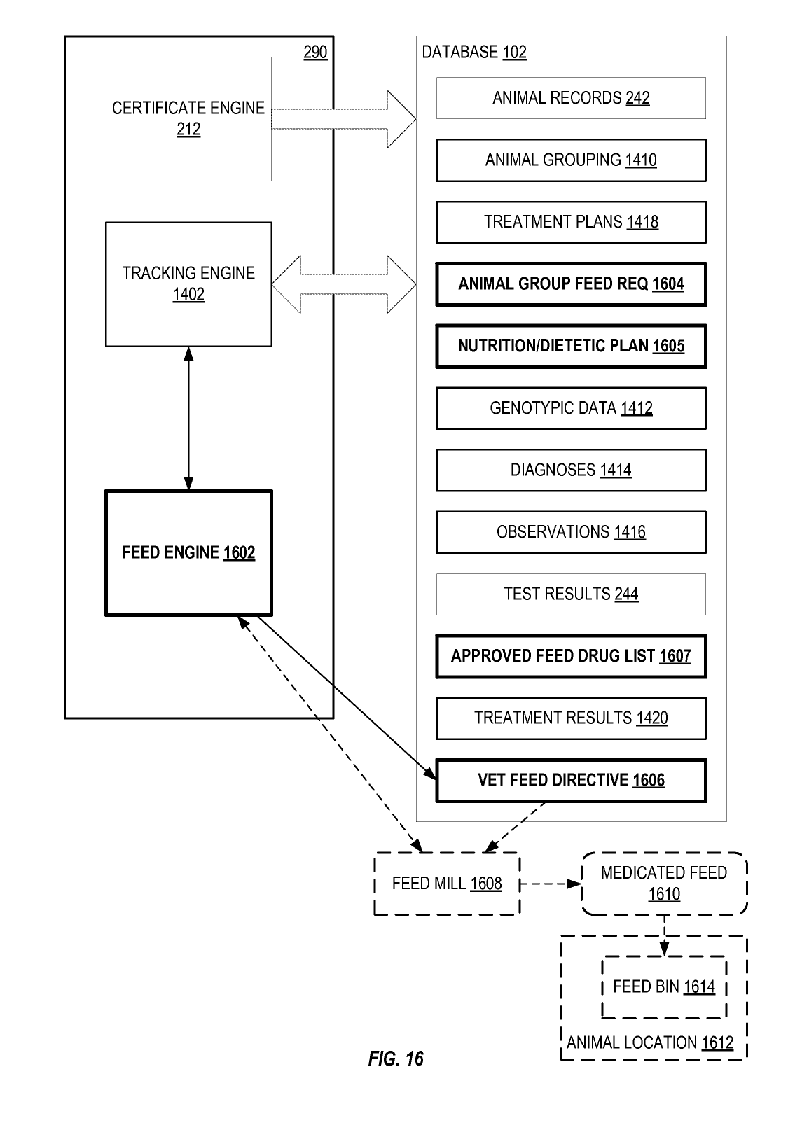

Step 1516 is optional. If included, in step 1516, method 1500 generates an electronic veterinary feed directive. In one example of step 1516, feed engine 1602 (see FIG. 16 and associated description) generates veterinary feed directive 1606 based upon one or more of treatment plans 1418, animal grouping 1410, animal group feed requirements 1604, nutrition/dietetic plan 1605, rules 160, regulations 162, and approved feed drug list 1607.

System 100, certificate engine 212, and tracking engine 1402 as described above overcome the problems of the prior art by:
1) Providing a complete herd health solution for disease traceability and antibiotic usage based upon stored information of past conditions, treatments, and result. The stored information allows system 100 to select and display the best prescribed treatment for the selected animals using far more than diagnosis alone.
2) Capturing and collecting data in real-time (i.e., as the data becomes available from user input and other connected systems) to consistently monitor and analyze disease prevalence, treatment and outcomes. System 100 integrates production data, diagnostics, treatments, and outcomes, making this data available for use in selecting ideal treatment plans based upon previous experience.
3) System 100 increases visibility of aggregate data for emerging disease trends as well as judicious use of antibiotics. By automatically collecting and storing information of diagnostic testing, system 100 provides a very good source of accumulated data from increasing groups and populations of animals, thereby allowing this data to be used for monitoring emerging diseases and/or disease trends.
4) Providing ease of tracking specific animals and/or groups of animals by storing information in a consistent way and providing consistent methods for accessing the data. By standardizing the collection, storing, and processing of the data, tools for using the data are simplified and also made more consistent.

Tracking engine 1402 operates to select an ideal vaccine and/or antibiotic (or other treatment) for an animal based upon a current diagnosis (e.g., from lab test results) and historical data collected by system 100 that includes previous treatments and effectiveness of those treatments on animals having similar DNA and/or RNA sequence data (e.g., genetic markers). Tracking engine 1402 also considers the production (or related) stage of the animals and environmental conditions, such as location, climate, and skill/experience of the farm staff and may prioritize a plurality of recommended treatment plans 1418. For example, tracking engine 1402 may provide three treatment plan options, each suitable for treating the animal and each including a probability of success based upon historical use of similar treatment plans on similar animals under similar conditions.

Improved Animal Certification Control

By improving the storage and consistency of information within database 102, certificate engine 212 may generate a specific certificate for animal movement, or animal health validation purposes, based upon accumulated diagnostic and treatment data for that animal. For example, certificate engine 212 validates the current health status of the animal or population of animals based upon the accumulated diagnostic and treatment data, and thus the generating requirements for the certificate accordingly. For example, certificate engine 212 may cooperate with tracking engine 1402 to generate an acceptable treatment and health status for movement of an animal based upon known treatments, conditions for the animal, including regulatory movement requirements as well as non-regulated movements. For example, pigs only are transportable based upon specific results from a laboratory for a certain type of approved regulatory test, thus certificate engine 212 and/or tracking engine 1402 may automatically select the appropriate laboratory to perform the test when the movement certificate request is entered based upon the required test results.

Software 290 may also include a validation engine 1401 that validates the use of each drug on each animal to identify where a drug may not be appropriate for an animal that has previously been treated with or is currently being treated with another drug that may conflict or react with a currently or previously prescribed drug for that animal, and prevents the use of a drug where rules and regulations prohibit its use under certain conditions, and so on. For example, validation engine 1401 may generate an alert 1499 that is sent to one or more of the veterinarian and the animal owner when a conflict is identified. In one embodiment, validation engine 1401 automatically specifies an alternative drug that is without conflict with the animal and updates treatment plan 1418 accordingly.

Veterinarian Feed Directive

FIG. 16 shows further exemplary detail of software 290 and database 102 of system 100 of FIG. 1, illustrating a feed engine 1602 that is implemented as machine readable instructions within software 290 that are executable to generate a veterinary feed directive 1606 based upon one or more of treatment plans 1418, animal records 242, and animal grouping 1410. Feed engine 1602 communicates with tracking engine 1402 and database 102 to generate veterinary feed directive 1606 based upon input from an accredited veterinarian and one or more of approved feed drug list 1607, disease trends report 1430, treatment trends report 1432, treatment evaluation report 1434, treatment prediction report 1436, and prevention report 1438. Approved feed drug list 1607 is for example a database table that defines medications that are approved by the FDA for addition to animal feed within feed engine 1602.

By communicating with tracking engine 1402, feed engine 1602 may provide guidance, advice, and/or statistical information as to effectiveness of previously used medicated feed 1610 in similar animal circumstances, and may thereby predict effectiveness of the treatment using medicated feed 1610, such as by generating treatment prediction report 1436 via tracking engine 1402.

Feed engine 1602 may first generate an animal group feed requirement 1604 when multiple animals (e.g., a beef herd) are to be similarly treated using the same medicated feed. Animal group feed requirement 1604 may identify a specific feed bin (e.g., feed bin 1614) at a specific animal location (e.g., animal location 1612), such as a farm. Animal group feed requirement 1604 may further define a quantity of feed required for an animal group as determined from animal records 242 and/or animal grouping 1410. Based upon treatment plan 1418, feed engine 1602 may automatically generate and send subsequent veterinary feed directives 1606 to feed mill 1608, such that medicated feed 1610 is delivered to the animal owner prior to being needed.

As with other medicines prescribed within treatment plans 1418, tracking engine 1402 monitors the effect of the medication on the animal(s) and determines one or more of disease trends report 1430, treatment trends report 1432, treatment evaluation report 1434, treatment prediction report 1436, and prevention report 1438, based upon use of medicated feed 1610 in association with the specific environmental conditions of the animal(s). Such information may be provided to the veterinarian to allow generation of an optimal veterinary feed directive 1606 for the current animal circumstances and diagnosis. Further, feed engine 1602 evaluates veterinary feed directive 1606 against approved feed drug list 1607 and other rules and regulations to eliminate error and misuse of drugs and medication. In one example feed engine 1602 interacts with validation engine 1401 to ensure correct use of each drug on each animal.

Veterinary feed directive 1606 is automatically sent to an appropriate feed mill 1608 that produces medicated feed 1610 based upon the feed directive. The feed mill 1608 is automatically selected based upon one or more of location, medication type, animal type, and feed type. Veterinary feed directive 1606 also specifies an animal location 1612 and a feed bin 1614 for receiving medicated feed 1610 such that labelling of medicated feed 1610 conforms to FDA requirements.

Veterinary feed directive 1606 may specify automatic reordering of medicated feed 1610, wherein feed engine 1602 generates a reminder (e.g., an email, a text message, or other such alert) for one or more of the veterinarian, the animal owner, and the feed mill 1608 two weeks prior to the expiration date. In one embodiment, feed engine 1602 communicates with feed mill 1608 to deliver veterinary feed directive 1606 and to receive information on drugs actually applied to medicated feed 1610, such as when a generic drug is substituted, or when an equivalent drug is used in place of a specified drug.

System 100 records veterinary feed directives 1606 in association with animal records 242 and treatment plans 1418 and determined results of the treatments (e.g., treatment evaluation report 1434) such that cost and effectiveness of the treatment may be evaluated against resultant productions from the treated herd or animal group.

System 100 may be accessed using a browser running on one of a mobile computer (e.g., a smart phone, a tablet, and so on), and a desktop computer.

FeedLINK Electronic Veterinary Feed Directive (eVFD) System Features

Feed engine 1602 implements one or more of the following features:

Feed engine 1602 may take into account requirements/recommendations by species, production phase, location and product label
Feed engine 1602 may generate a Compendium Feature of FDA labels:
   Dropdown list of all FDA-approved Veterinary Feed Directive drugs
   Label indicates renewal and refill request notifications
   Label applied directly to the Veterinary Feed Directive (VFD) form per the GFI 213 requirements (see for example, http://www.fda.gov/downloads/animalveterinary/guidancecomplianceenforcement/guidanceforindustry/ucm299624.pdf and http://www.fda.gov/AnimalVeterinary/Products/AnimalFoodFeeds/IngredientsAdditives/default.htm
Feed engine 1602 may generate Renewals
   Every 6 months unless otherwise stated on the drug manufacturers label
   Built in email reminder notifications 2 weeks prior to expiration date
Feed engine 1602 may include a refill feature (within expiration period) to automatically reorder medicated feed 1610.
Feed engine 1602 may include Integration Web Services
   Provides connectivity and accessibility through technology software providers
   Feed Suppliers—records the drug that was actually utilized and mixed, along with quantity vs. the drug that was listed on the original VFD order
   Production Herd Software—Sum of how much feed and drug was actually fed—and what was reclaimed.
Feed engine 1602 may be designed with mobile optimization & include a free-standing application

System 100 may be used for tracking an order (drug) from (a) a veterinarian submission of an order to a supplier, (b) to fulfillment, (c) to delivery at a specific premises number and bin identifier, and may include a process to confirm receipt of delivery. System 100 may also include functionality to receive tracking information from farm production software indicating use of the VFD order (drug) such as when medicated feed is taken from the feed bin to and delivery to the animal. System 100 may monitor and report inventory of VFD order (drug) throughout the supply chain from supplier to consumption by animal.

System 100 may electronically trace and track movement of veterinary feed directive 1606 and medicated feed 1610 including information on volume, date and geographic location. For example, system 100 may receive tracking information from other computer systems utilized by feed mill 1608 and transport companies delivering medicated feed 1610, and from farm production software that tracks use of medicated feed with certain animals. Tracking engine 1402 may record and validate this movement and use of medicated feed 1610 and generate alerts when the feed is used incorrectly and may provide compliance information for correct use of medicated feed 1610.

Rules 160 and/or regulations 162 may define requirements for veterinary feed directive 1606 and medicated feed 1610 that allow feed engine 1602 to automatically validate and confirm compliance throughout the workflow process and throughout the supply chain.

Feed engine 1602 may generate one or more notifications for actions to be performed external to system 100 and/or may generate notifications to indicate items in violation of the rules or requirements (e.g., as defined within rules 160 and regulations 162).

Feed engine 1602 may enable users within the supply chain to adjust future orders based upon information tracked on previous veterinary feed directive orders.

Feed engine 1602 may automatically generate recommendations for “Change Orders, Stop Orders, and Order Relocations” based upon information collected from users and from previous orders.

System 100 may also utilize lab data (e.g., test results 244) from diagnostics to generate an informed treatment plan. For example, tracking engine 1402 may include a digital method to track, trace and indicate drug residuals throughout the lifecycle of an animal, and during a treatment period. Tracking engine 1402 may measure, monitor and estimate the level of residues of drugs within the animal. For example, tracking engine 1402 may include a digital method to collect, analyze and synthesize data to estimate the amount of drug residues based upon one or more of animal records 242, animal groupings 1410, genotypic data 1412, diagnoses 1414, observations 1416, lab submissions 1417, test results 244, treatment plans 1418, and treatment results 1420. For example, by processing historical data within database 102 using intelligent algorithms within tracking engine 1402, system 100 may predict drug residuals within any treated animal.

Tracking engine 1402 and/or feed engine 1602 may include a digital method to track, trace and indicate drug label compliance and potential warning of a potential allergen, drug mix issue, dietary restrictions impacting efficacy of the drug, etc. For example, tracking engine 1402 may track drugs supplied and delivered to the patient/animal through one or more of feed, water, topical or injectable. System 100 may monitor the drug use history and provide a warning to the user where imminent use of a prescribed drug may not mix with drugs already provided to the patient/animal. System 100 may then generate a list of alternative drugs to the drug requested such that treatment may proceed with a safer drug. System 100 may indicate to the user if the drug requested complies with the patient's/animal's nutrition plan or dietetic plan 1605.

Tracking engine 1402 may predict and indicate any potential results from use of the drug based upon one or more of animal records 242, animal groupings 1410, genotypic data 1412, diagnoses 1414, observations 1416, lab submissions 1417, test results 244, treatment plans 1418, and treatment results 1420. For example, an algorithm within tracking engine 1402 may predict results of using the drug based upon correlated (e.g., based upon one or more of similar conditions, symptoms, animal types, locations, etc.) historical data within database 102.

System 100 may include a digital method to automate the generation of a treatment plan or health management plan based upon the results and/or outcomes the user indicates as desired outcomes and/or results.

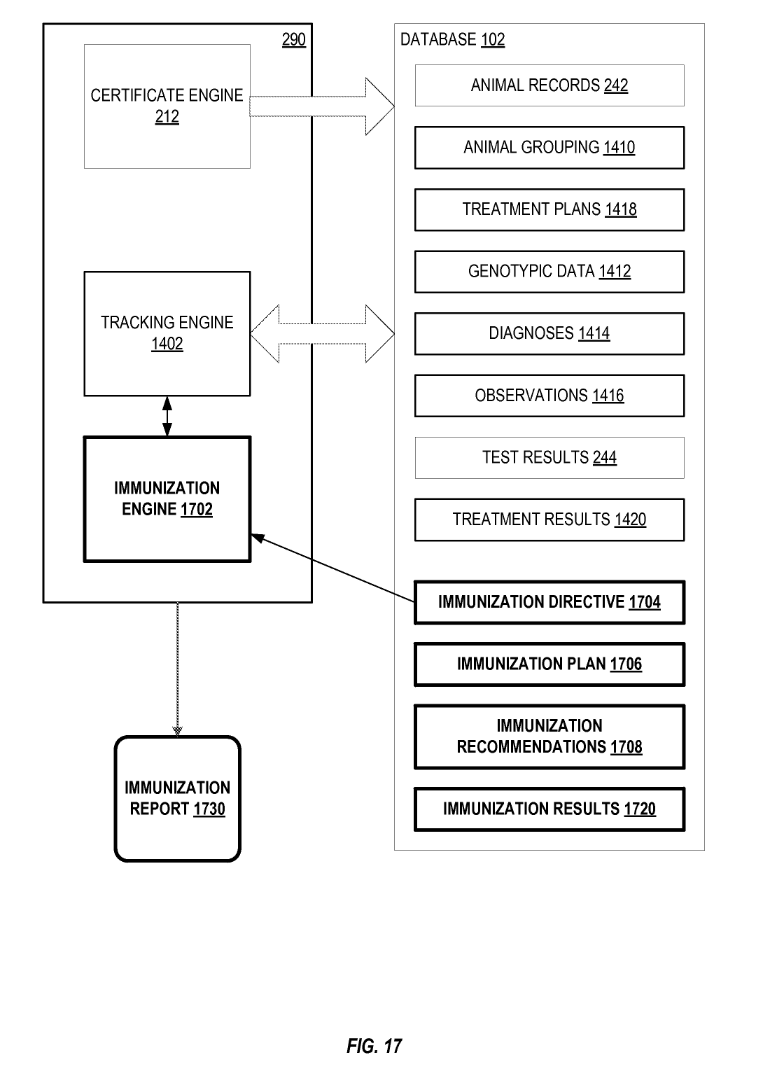

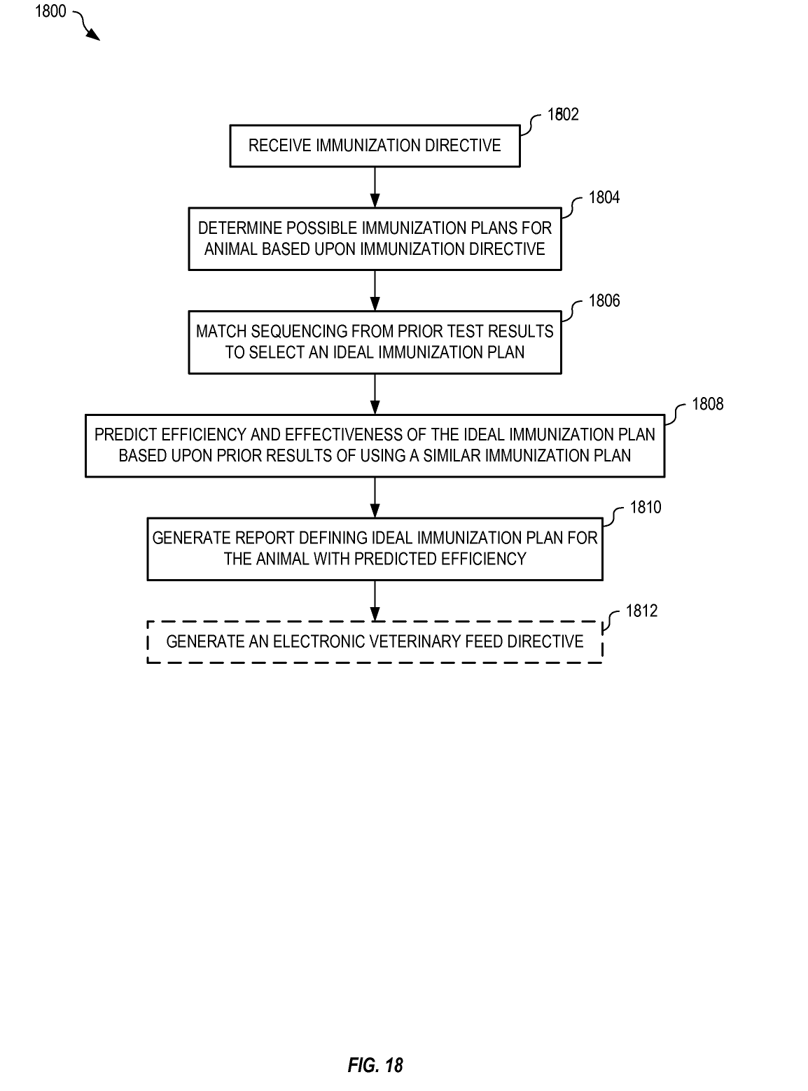

FIG. 17 shows further exemplary detail of software 290 and database 102 of system 100 of FIG. 1, illustrating an immunization engine 1702 implemented as machine-readable instructions stored within software 290 that are executable (e.g., by processor 204, FIG. 2) to generate a veterinary feed directive 1606 based upon correlated (e.g., based upon one or more of similar conditions, symptoms, animal types, locations, etc.) historical data within database 102. FIG. 18 shows one exemplary method 1800 for determining an ideal immunization plan and predicting results of the immunization plan. Method 1800 is for example implemented within immunization engine 1702 of FIG. 17. FIGS. 17 and 18 are best viewed together with the following description.

In step 1802, method 1800 receives an immunization directive. In one example of step 1802, system 100 receives an immunization directive 1704 from a veterinarian (e.g., veterinarian 144) and stores immunization directive 1704 within database 102. In step 1894, method 1800 determines possible treatments for animals based upon an immunization plan. In one example of step 1804, immunization engine 1702 generates one or more immunization plans 1706 based upon immunization directive 1704 and one or more of animal records 242, animal groupings 1410, genotypic data 1412, diagnoses 1414, observations 1416, test results 244, treatment plans 1418, immunization results 1720, and treatment results 1420. Each immunization result 1720 shows the result and effectiveness of one immunization plan 1706 that was applied to a particular animal or group of animals. Information received from production management software may be used by tracking engine 1402 to evaluate immunizations performed on the animals and to generate immunization results 1720. For example, immunization results 1720 may include a list of past immunizations for a specific diagnosis and animal type, species, etc., and may include information on pathogen susceptibility to a specific drug, animal immune response, and/or disease prevalence change, based on specific immunizations per diagnosis.

In step 1806, method 1800 matches sequencing from prior test results to select an ideal immunization plan. In one example of step 1806, immunization engine 1702 processes one or more of animal records 242, animal groupings 1410, genotypic data 1412, diagnoses 1414, observations 1416, test results 244, treatment plans 1418, immunization results 1720, and treatment results 1420 to match one or both of DNA and RNA sequencing of the animal with records of other animals having previously used at similar (or the same) immunization plan to identify an ideal immunization plan 1706 for the animal. Specifically, where one drug performs better than another drug for an animal with a certain DNA or RNA sequence (e.g., a genetic marker), where that sequence is also present in the current animal, results of the immunization plan using the same drug on the current animal may be predicted to allow selection of the ideal immunization plan 1706.

In step 1808, method 1800 predicts efficiency and effectiveness of the ideal immunization plan based upon the prior results of using a similar immunization plan. In one example of step 1808, immunization engine 1702 processes one or more of animal records 242, animal groupings 1410, genotypic data 1412, diagnoses 1414, observations 1416, test results 244, treatment plans 1418, immunization plans 1706, immunization results 1720, and treatment results 1420 to predict efficiency and effectiveness of immunization plan 1706 on the animal by selecting results of similar plans and drugs on similar animals in similar conditions.

In step 1810, method 1800 generates a report defining the ideal immunization plan for the animal with predicted efficiency. In one example of step 1810, immunization engine 1702 generates immunization report 1730 to provide details of ideal immunization plan 1706 and predicted efficiency and/or effectiveness.

Step 1812 is optional. If included, in step 1812, method 1800 generates an electronic veterinary feed directive. In one example of step 1812, immunization engine 1702 interacts with feed engine 1602 to automatically generate veterinary feed directive 1606 based upon ideal immunization plan 1706 such that the selected drug is administered to the animal within medicated feed 1610.

Smart Connection:

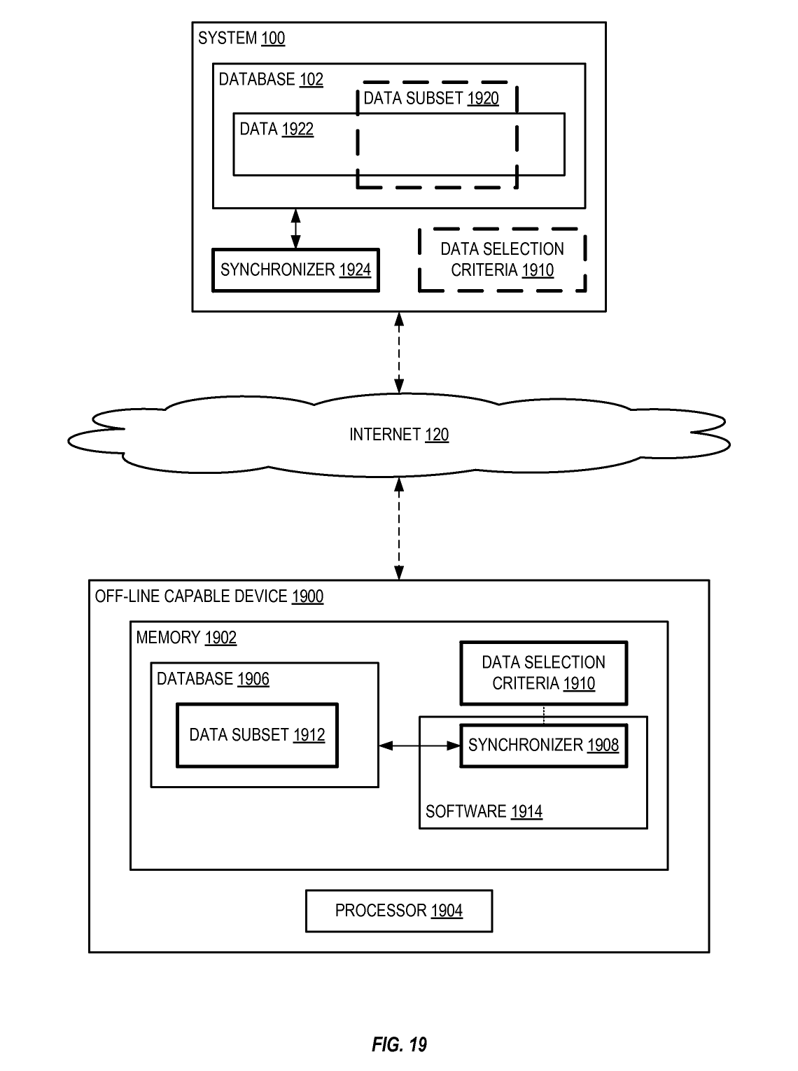

FIG. 19 shows one exemplary off-line capable device 1900 for implementing certain functionality of system 100, FIG. 1, without requiring continuous connectivity to system 100. Accordingly, device 1900 may provide functionalities described in methods 300, 400, 600, 1300, 1500 and shown in system 100, as discussed above. Device 1900 includes a memory 1902 (e.g., RAM, ROM, volatile, non-volatile, FLASH, magnetic, and/or optical data storage) and a processor 1904 that operated to execute machine-readable instructions of software 1914 stored within memory 1902 to implement functionality of device 1900. Device 1900 is for example one of a personal computer, a laptop computer, a notebook computer, a smart phone, a tablet computer, and other similar devices that include Internet and network connectivity.

To implement offline capabilities of system 100 within device 1900, device 1900 is initially connected with system 100, for example via Internet 120 and wired and/or wireless connectivity, wherein a synchronizer 1908, that is part of software 1914, interacts with a synchronizer 1924 running within system 100 to transfers and/or synchronizes at least part of data 1922 within of database 102 to a database 1906 within device 1900. Database 102 of system 100 contains records and data relating to all users of system 100 and does not necessarily lend itself to easy transfer to a device 1900. However, by specifying (e.g., by interacting with device 1900) an intended use of device 1900, synchronizer 1908 may define a data selection criteria 1910 that is transferred to system 100 such that synchronizer 1924 may select a data subset 1920 of data 1922 for synchronization with, or transfer to, database 1906 of device 1900.

In one example of operation, a user of device 1900 is a veterinarian with a planned visit to a particular farm, wherein by interacting with device 1900 and indicating the farm of the intended visit, synchronizer 1908 may define data selection criteria 1910 to select data subset 1920 containing information relevant only to that particular farm. Device 1900, while still at the veterinary practice, communicates with system 100 to synchronize database 1906 with data subset 1920 containing information associated with the farm. Device 1900 then disconnects from system 100, wherein the veterinarian may access information relevant to the farm within database 1906. The veterinarian may modify certain information within database 1906, and may generate and store new information relevant to the farm within database 1906. When the farm visit is completed, the veterinarian returns to the veterinary practice for example, and device 1900 reconnects with system 100, wherein synchronizer 1908 and synchronizer 1924 cooperate to update database 102 based upon changes to database 1906.

Data subset 1920 is not limited to information related to a single entity. Data selection criteria 1910 may specify more one or more entities (e.g., farms, specific animal, and/or users) for selection of information for data subset 1920. For example, data subset 1912 may include all data from database 102 that relate to rules 160 and regulations 162 that state vet 130 could utilize during operation of device 1900. As another example, data subset 1912 may include all data within database 102 associated with owner 148—such as rules 160 and regulations 162 associated with each animal 149 owner 148 has registered; any procedures 164, certificates 166, animal records 242, test results 244, animal grouping 1410, genotypic data 1412, diagnoses 1414, observations 1416, lab submissions 1417, treatment plans 1418, treatment results 1420, lab capability data 1422, animal group feed requirements 1604, approved feed drug list 1607, and vet feed directive 1606 associated with owner 148.

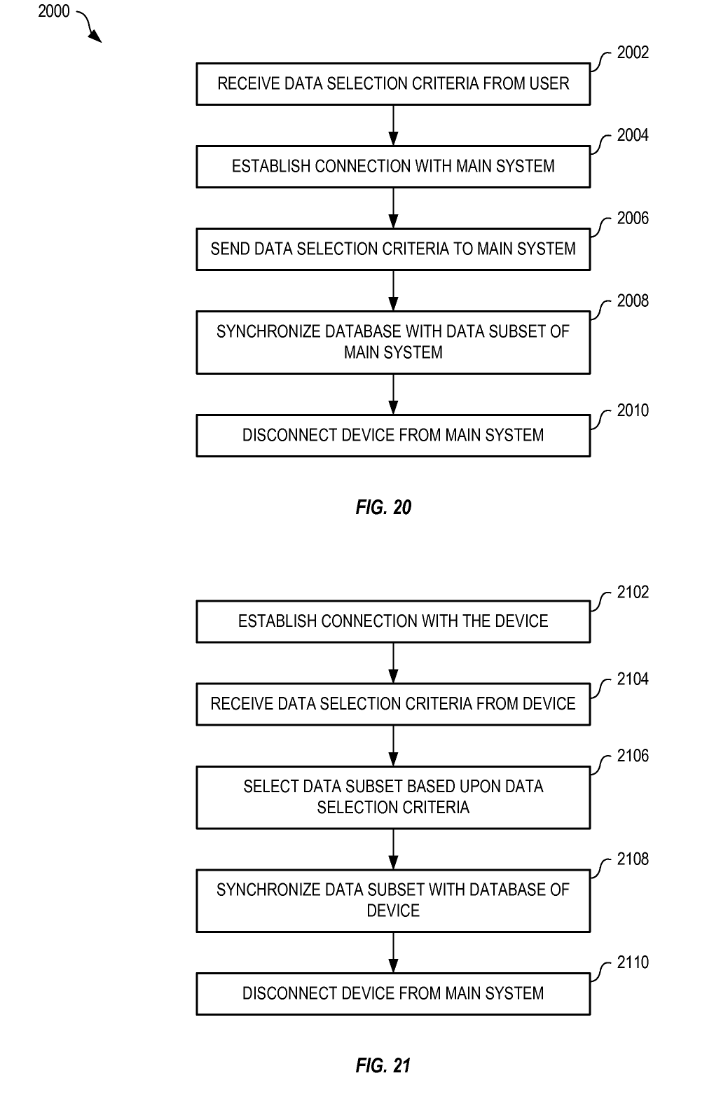

FIGS. 20 and 21 are flowcharts illustrating exemplary methods 2000, 2100 for preparing device 1900 for off-line operation. Method 2000 is implemented within synchronizer 1908 of device 1900 and method 2100 is implemented within synchronizer 1924 of system 100 for example.

In step 2002, method 2000 receives data selection criteria from a user. In one example of step 2002, a veterinarian interacts with synchronizer 1908 to select a location for an upcoming visit to define data selection criteria 1910. In step 2004, method 2000 establishes a connection with the main system. In one example of step 2004, software 1914 establishes a connection, via Internet 120, with system 100. In step 2006, method 2000 sends the data selection criteria to the main system. In one example of step 2006, synchronizer 1908 sends data selection criteria 1910 to synchronizer 1924.

In step 2008, method 2000 synchronizes the database with a data subset of the main system. In one example of step 2008, synchronizer 1908 cooperates with synchronizer 1924 (see step 2108 of method 2100) to receive data subset 1912 from system 100. In step 2010, method 2000 disconnects the device from the main system. In one example of step 2010, software 1914 disconnects device 1900 from system 100.

In step 2102, method 2100 establishes a connection with the off-line capable device. In one example of step 2102, software 290 interacts, via Internet 120, with device 1900, where device 1900 provides login and password information that is authenticated by software 290 to allow connectivity of device 1900 with system 100. In step 2104, method 2100 receives data selection criteria from the device. In one example of step 2104, synchronizer 1924 receives data selection criteria 1910 from synchronizer 1908 of device 1900. In step 2106, method 2100 selects a data subset based upon the data selection criteria. In one example of step 2106, synchronizer 1924 selects data subset 1912 from data 1922 of database 102 based upon data selection criteria 1910.

In step 2108, method 2100 synchronizes the data subset with the database of the device. In one example of step 2108, synchronizer 1924 cooperates with synchronizer 1908 (see step 2008 of method 2000) to synchronize database 1906 with data subset 1912 such that data subset 1912 is stored in database 1906 of device 1900. In step 2110, method 2100 disconnects the device from the main system. In one example of step 2110, software 290 disconnects device 1900 from system 100.

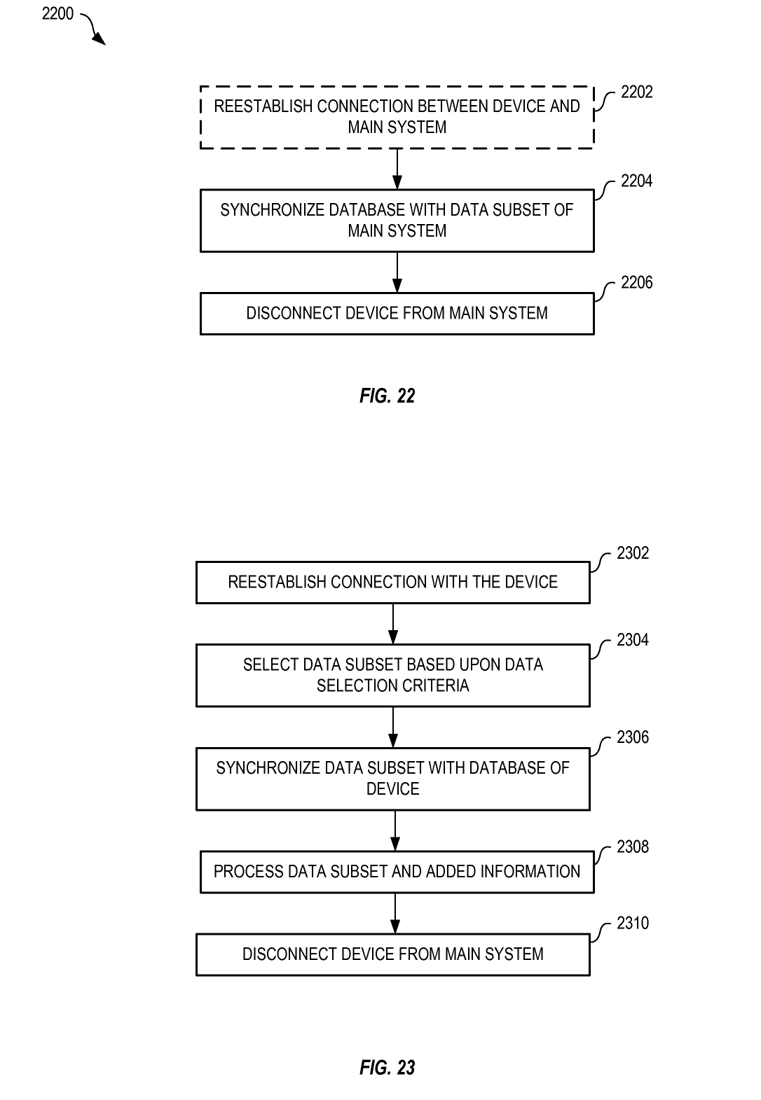

FIGS. 22 and 23 are flowcharts illustrating exemplary methods 2200, 2300 for resynchronizing system 100 with device 1900 after off-line operation of device 100. Method 2200 is implemented within synchronizer 1908 of device 1900 and method 2300 is implemented within synchronizer 1924 of system 100 for example.

In step 2202, method 2200 reestablishes connection between the device and the main system. In one example of step 2202, software 1914 establishes a connection, via Internet 120, with system 100. In step 2204, method 2200 synchronizes the database with the data subset of the main system. In one example of step 2204, synchronizer 1908 cooperates with synchronizer 1924 (see step 2306 of method 2300) to update database 102 based upon information changed within database 1906. In step 2206, method 2200 disconnects the device from the main system. In one example of step 2206, software 1914 disconnects device 1900 from system 100.

In step 2302, method 2300 reestablishes connection with the off-line capable device. In one example of step 2302, software 290 reestablished a connection from system 100 to device 1900 using login and password authentication. In step 2304, method 2300 selects the data subset based upon the data selection criteria. In one example of step 2304, synchronizer 1924 selects data subset 1912 from database 102 based upon data selection criteria 1910, where data selection criteria 1910 may have been saved within system 100 from the previous connection or resent from device 1900. In step 2306, method 2300 synchronizes the data subset with the database of the device. In one example of step 2306, synchronizer 1924 cooperates with synchronizer 1908 to receive information changed within data subset 1912 of database 1906 and updates data subset 1912 within database 102 accordingly. Synchronizer 1924 may further add new records from database 1906 to database 102.

In step 2308, method 2300 processes the data subset and added information. In one example of step 2308, synchronizer 1924 invokes functionality of software 290 to process data subset 1912 and added records to further update database 102. For example, synchronizer 1924 may invoke software 290 to generate one or more reports (e.g., one or more of disease trends report 1430, treatment trends report 1432, treatment evaluation report 1434, treatment prediction report 1436, and prevention report 1438), treatment plans 1410, veterinary feed directives 1606, immunization plans 1706, and so on.

In step 2310, method 2300 disconnects the device from the main system. In one example of step 2310, software 290 disconnects device 1900 from system 100.

Once data subset 1912 is stored within database 1906, device 1900 may operate offline to provide at least part of the functionality of system 100 described above. Device 1900 may store requests 174, generated by an owner for example, that are transferred to system 100 during resynchronization and actioned in step 2308 of method 2300.

Within device 1900, software 1914 provides functionality similar to one or more of requirement interpreter 210, certificate engine 212, information validator 214, certificate producer 216, certificate validator 218, tracking engine 1402, feed engine 1602, and immunization engine 1702. Device 1900 thereby provides off-line functionality that is similar to system 100. The ability of device 1900 to function completely off-line from system 100 provides a significant advantage to users who travel frequently, and for users who travel in rural areas where Internet connection is not available. In one embodiment, device 1900 operates both as on-line and off-line, wherein device 1900 operates similarly to a browser (e.g., browser 134, 140, and so on) to interact with system 100 as described above to automatically determine and download data subset 1912 to database 1906 such that device 1900 may continue operating when offline from system 100.

In one embodiment, resynchronization between device 1900 and system 100 occurs at any time when connectivity between device 1900 and system 100 becomes available, wherein device 1900 then provides full functionality of system 100.

Automatic Action Generation

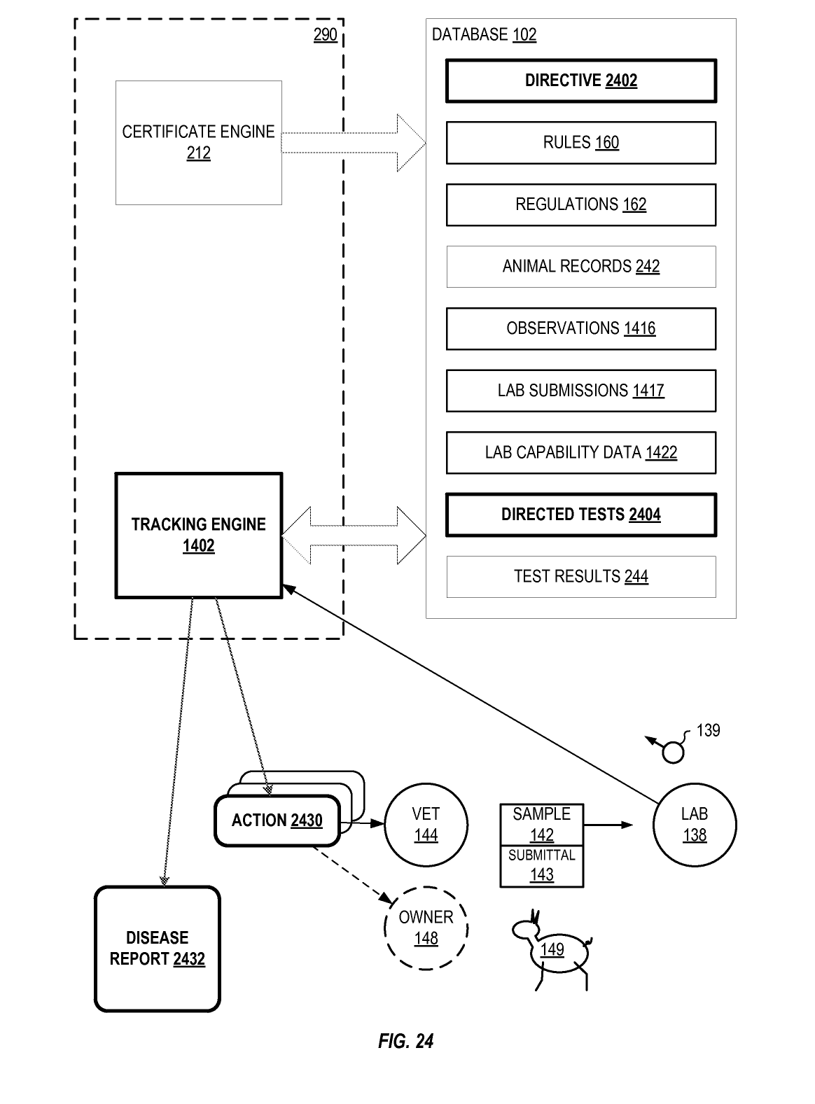

FIG. 24 shows further exemplary detail of software 290 and database 102 of system 100 of FIG. 1, illustrating automatic testing of one or more animals based upon a directive 2402. Directive 2402 is for example a federal government order that requires certain types of animal to be tested for a certain disease or condition. For example, directive 2402 may require testing of all swine for presence of Swine Enteric Corona Viruses and/or PEDv to monitor and control spread of the diseases.

A government official (e.g., state veterinarian 130 and/or state official 190) may send directive 2402 to system 100, where it is shown stored within database 102. See for example http://www.aphis.usda.gov/newsroom/2014/06/pdf/secd_federal_order.pdf. Tracking engine 1402 processes directive 2402 and automatically identifies animals within animal records 242 for testing to comply with directive 2402, and for example, tracks these animals and tests within a directed tests table 2404 within database 102. For example, where directive 2402 specifies testing of all swine for PEDv within a particular geographic area, tracking engine 1402 selects all swine from animal records 242 that are located within that geographic area and stores references to these animals within directed tests table 2404.

Tracking engine 1402 then generates one or more actions 2430 that are sent to veterinarians (e.g., veterinarian 144) associated with, and/or owners (e.g., owner 148) of, the identified animals indicating that one or more specific tests defined within directive 2402 are required. For example, each action 2430 may identify a specific animal or group of animals, specify the type of sample to be collected, and identify a laboratory for receiving and processing the sample. Tracking engine 1402 may also generate submittals 143, as described above, for accompanying and tracking samples 142 collected by the veterinarian from each animal and system 100 may provide forms for receiving test results 139 from one or more laboratories automatically selected for testing the samples 142. Where more than one action 2430 is sent to any one veterinarian 144, tracking engine 1402 may collate and/or group these actions and submittals 143 according to one or both of owner and animal location to facilitate collection of samples 142.

Tracking engine 1402 then coordinates collection of samples 142, submission of the samples to one or more selected laboratories 138, and then automatically collects and processes test results 139 when they are received from the laboratories 138. Once all test results 139 are received (or upon request or when specified within directive 2402), tracking engine 1402 generates a disease report 2432 containing at lease a summary of test results 139 associated with directive 2402. Disease report 2432 is for example automatically delivered to the appropriate organization or animal health official as specified within directive 2402.

In another example of operation, where rules 160 indicate that certain types of animal should be periodically tested for certain diseases, tracking engine 1402 automatically generates actions and submittals 143 to ensure that each animal within animal records 242 comply to the rules 160.

Thus, tracking engine 1402 facilitates compliance to rules and regulations, and facilitates compliance with directives that require specific tests on certain types of animal to track and help prevent diseases.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A computer-implemented method for automatically generating an electronic veterinary feed directive for an animal based upon a diagnosis of the animal, comprising the steps of:
determining, within the computer, a diagnosis of the animal based upon test results received from a laboratory for at least one test of the animal;
determining, within the computer, a plurality of possible treatment plans for the animal based upon information of the animal and the diagnosis;
selecting, within the computer and from the plurality of treatment plans, an ideal treatment plan for the animal based upon the information of the animal, the test results, the diagnosis, and treatment results of previously followed treatment plans for animals having similar diagnosis, age, and production stage; and
generating a veterinary feed directive based upon the ideal treatment plan.

2. The computer implemented method of claim 1, the step of selecting further comprising matching environmental conditions of the animal to environmental conditions of animals associated with the treatment results of previously followed treatment plans.

3. The computer implemented method of claim 1, wherein the ideal treatment plan is the treatment plan having corresponding matched treatment results indicating the greatest success.

4. The computer implemented method of claim 1, the step of selecting comprising matching at least one genetic marker within the test results to a corresponding genetic marker stored within test results associated with animals identified within the treatment results, wherein the ideal treatment plan is selected based upon the most successful of the treatment results of previously followed treatment plans for animals having matching genetic markers.

5. The computer implemented method of claim 4, the genetic marker comprising a DNA sequence.

6. The computer implemented method of claim 4, the genetic marker comprising an RNA sequence.

7. The computer implemented method of claim 1, further comprising:
receiving, within the computer and from a feed nutritionist or a laboratory, feed analysis results for one or more ration feedstuffs or ration components; and
automatically validating medication provided to the animal based upon the feed analysis results against medication indicated in the treatment plan.

8. The computer implemented method of claim 1, further comprising:
determining a conflict between one or more drugs specified within the treatment plan and other drugs currently or previously prescribed for and/or administered to the animal; and
generating an alert indicating the conflict.

9. The computer implemented method of claim 1, further comprising determining residual drug levels within an animal based upon treatment plans generated for the animal.

10. The computer implemented method of claim 1, further comprising automatically sending the feed directive to a feed mill to initiate production and delivery of a medicated feed based upon the ideal treatment plan.

11. The computer implemented method of claim 10, further comprising receiving tracking information from other computer systems and automatically validating correct use of the medicated feed.

12. The computer implemented method of claim 11, further comprising generating an alert when the medicated feed is used incorrectly.

13. A computer implemented method for selecting an immunization plan for an animal based upon predicted effectiveness of the immunization plan and immunization option recommendation, comprising the steps of:
receiving, within a computer, an immunization directive for an animal;
determining, within the computer, at least one immunization plan for the animal based upon the immunization directive; and
determining an ideal immunization plan for the animal based upon stored first information of the animal, test results associated with the animal, and immunization results of previously followed immunization plans for other similar animals.

14. The computer implemented method of claim 13, the step of determining the ideal immunization plan comprising matching at least part of the first information to at least part of second information of the other similar animals, wherein the ideal immunization plan is selected based upon the most successful of the immunization results and the closes match between the first information and the second information.

15. The computer implemented method of claim 14, the step of matching comprising matching first genetic markers within the first information to second genetic markers within the second information, wherein the ideal immunization plan is selected based upon matches between the first and second genetic markers.

16. The computer implemented method of claim 15, the first and second genetic markers each comprising at least a portion of a DNA sequence.

17. The computer implemented method of claim 15, the first and second genetic markers each comprising at least a portion of an RNA sequence.

18. A computer implemented method for predicting effectiveness of a treatment plan for a particular animal, comprising:
selecting a statistically significant plurality of other animals that are similar to the particular animal and that have followed the treatment plan;
selecting treatment results associated with the treatment plan for the other animals; and
predicting effectiveness of the treatment plan on the animal based upon indicated effectiveness in the treatment results.

19. The computer implemented method of claim 18, wherein the other animals each have a diagnosis similar to the particular animal.

20. The computer implemented method of claim 18, the step of predicting comprising adjusting the effectiveness based upon similarity between the particular animal and the other animals, wherein the similarity comprises one or more of animal type, animal size, animal condition, animal age, animal weight, and animal environmental conditions.

21. The computer implemented method of claim 18, the step of predicting comprising adjusting the effectiveness based upon matches of genetic markers between the particular animal and the other animals.

22. The computer implemented method of claim 21, the genetic markers comprising at least part of a DNA sequence.

23. The computer implemented method of claim 21, the genetic markers comprising at least part of an RNA sequence.

24. A computer-implemented system for animal certification with offline accessibility, comprising:
a first computer having a first processor, a first interface, and a first electronic database for storing information relating to a plurality of animals;
an off-line capable device comprising a second computer having a second processor, a second web interface for communicating with the first computer, and a second electronic database for storing at least part of the information;
a synchronizer, implemented by the second processor, capable of (a) receiving the at least part of the information from the first electronic database prior to disconnecting from the first computer, and (b) sending updates to the information to the first electronic database when communication to the first computer is reestablished;
wherein the second computer operates to process the information both when in communication with the first computer and when not in communication with the first computer.

25. A computer implemented method for automatically identifying and testing animals, comprising:
selecting animals for testing based upon one of a directive and a rule;
generating actions to request sample collection from each of the animals;
receiving test results from one or more laboratories selected to receive and test the samples; and
generating a disease report including information of the test results for each of the animals.

26. The computer implemented method of claim 25, wherein the directive comprises a requirement to test for one or both of Swine Enteric Corona Viruses and Porcine Epidemic Diarrhea Virus (PEDv).

27. The computer implemented method of claim 25, the step of selecting comprising selecting the one or more animals based upon a disease defined within the directive or rule.

28. A computer-implemented method for determining an ideal treatment plan for a herd of animals, comprising the steps of:
testing a statistically significant sample individual animals of the herd for prevalence of a particular disease;
collecting at least two animal parameters for each animal of the statistically significant sample;
generating lab results determining the existence of the particular disease for each animal of the statistically significant sample;
comparing the generated lab results against a database containing information on the particular disease for animals matching the at least two parameters collected from the statistically significant sample; and
outputting an ideal herd treatment plan for the herd based on the results of the step of comparing.

29. The method of claim 28, wherein the animal parameters comprise one or more of animal age, weight, species, genotype, class, stage, gender, geo-location, past health history, and season.

30. The method of claim 28, further comprising the step of automatically customizing the ideal herd treatment plan for each individual animal of the herd according to at least one animal parameter of the particular individual animal.
